(19) United States
(12) Patent Application Publication
(10) Pub. No.: US 2026/0148427 A1
(43) Pub. Date: May 28, 2026

(54) CONSISTENT CHARACTER GENERATION FROM TEXT PROMPT

(71) Applicant: ADOBE INC., SAN JOSE, CA (US)

(72) Inventors: Aditi Singhania, Raipur (IN); Vineet Batra, Delhi (IN)

(21) Appl. No.: 18/957,777

(22) Filed: Nov. 24, 2024

(51) Int. Cl. G06T 11/00; G06F 40/40

(52) U.S. Cl. CPC G06T 11/00; G06F 40/40

(57) ABSTRACT

A method, apparatus, non-transitory computer readable medium, and system for image generation include obtaining a first prompt and a second prompt, where the first prompt describes an object in a first scene and the second prompt describes the object in a second scene different from the first scene. A first attention output and a second attention output are generated, using an image generation model, by performing a cross-image attention process on the first prompt and the second prompt. The image generation model generates a first synthetic image and a second synthetic image based on the first attention output and the second attention output, respectively, wherein the first synthetic image depicts the object in the first scene and the second synthetic image depicts the object in the second scene.

### BACKGROUND

The following relates generally to image processing, and more specifically to image generation using machine learning. Digital image processing refers to the use of a computer to edit a digital image using an algorithm or a processing network. In some cases, image processing software can be used for various tasks, such as image editing, image restoration, image generation, etc. Recently, machine learning models have been used in advanced image processing techniques. Among these machine learning models, diffusion models and other generative models such as generative adversarial networks (GANs) have been used for various tasks including generating images with perceptual metrics, generating images in conditional settings, image inpainting, and image manipulation.

Image generation, a subfield of image processing, involves the use of diffusion models to synthesize images. Diffusion models can be used for various image generation tasks including image super-resolution, generation of images with perceptual metrics, conditional generation (e.g., generation based on text guidance), image inpainting, and image manipulation. Specifically, diffusion models are trained to take random noise as input and generate unseen images with features similar to the training data.

### SUMMARY

The present disclosure describes systems and methods for image generation. Embodiments of the present disclosure include an image generation apparatus that provides a training-free, zero-shot model to generate consistent character images based on a set of text prompts that describe a same object (e.g., “a dog”). By performing a combination of inner cross-image attention process and an outer cross-image attention process, the image generation apparatus ensures that generated characters (of a same object) maintain consistency across multiple synthetic images that are generated based on different prompts (e.g., two or more prompts describing the same object within different scenes).

A method, apparatus, non-transitory computer readable medium, and system for image generation are described. One or more embodiments of the method, apparatus, non-transitory computer readable medium, and system include obtaining a first prompt and a second prompt, wherein the first prompt describes an object in a first scene and the second prompt describes the object in a second scene different from the first scene; generating, using an image generation model, a first attention output and a second attention output, wherein each of the first attention output and the second attention output is based on both the first prompt and the second prompt; and generating, using the image generation model, a first synthetic image and a second synthetic image based on the first attention output and the second attention output, respectively, wherein the first synthetic image depicts the object in the first scene and the second synthetic image depicts the object in the second scene.

A method, apparatus, non-transitory computer readable medium, and system for image generation are described. One or more embodiments of the method, apparatus, non-transitory computer readable medium, and system include obtaining a first prompt describing a first scene and a second prompt describing a second scene; performing a cross-image attention between the first prompt and the second prompt to obtain a first attention output corresponding to the first prompt and a second attention output corresponding to the second prompt; and generating, using the image generation model, a first synthetic image and a second synthetic image based on the first attention output and the second attention output, respectively

An apparatus, system, and method for image generation are described. One or more embodiments of the apparatus, system, and method include a memory component; a processing device coupled to the memory component; an image generation model comprising parameters stored in the memory component and configured to: generate a first attention output and a second attention output by performing a cross-image attention process, wherein the first attention output is based on a first prompt and a second prompt, wherein the second attention output is based on the first prompt and the second prompt, and wherein the first prompt describes an object in a first scene and the second prompt describes the object in a second scene different from the first scene; and generate a first synthetic image and a second synthetic image based on the first attention output and the second attention output, respectively, wherein the first synthetic image depicts the object in the first scene and the second synthetic image depicts the object in the second scene.

### BRIEF DESCRIPTION OF THE DRAWINGS

FIG. 1 shows an example of an image generation system according to aspects of the present disclosure.

FIG. 2 shows an example of a method for conditional media generation according to aspects of the present disclosure.

FIG. 3 shows an example of consistent subject generation with two prompts according to aspects of the present disclosure.

FIG. 4 shows an example of consistent subject generation with three prompts according to aspects of the present disclosure.

FIG. 5 shows an example of consistent subject generation with four prompts according to aspects of the present disclosure.

FIG. 6 shows an example of consistent subject generation with five prompts according to aspects of the present disclosure.

FIG. 7 shows an example of multi-subject prompt to image generation according to aspects of the present disclosure.

FIG. 8 shows an example of a method for image generation according to aspects of the present disclosure.

FIG. 9 shows an example of an image generation apparatus according to aspects of the present disclosure.

FIG. 10 shows an example of inner cross-image attention according to aspects of the present disclosure.

FIG. 11 shows an example of outer cross-image attention according to aspects of the present disclosure.

FIG. 12 shows an example of cross-attention map at an intermediate step across different layers according to aspects of the present disclosure.

FIG. 13 shows an example of predicted image at different diffusion timesteps according to aspects of the present disclosure.

FIG. 14 shows an example of comparison between uniform and log SNR scheduling according to aspects of the present disclosure.

FIG. 15 shows an example of a guided diffusion model according to aspects of the present disclosure.

FIG. 16 shows an example of a U-Net architecture according to aspects of the present disclosure.

FIG. 17 shows an example of a diffusion process according to aspects of the present disclosure.

FIG. 18 shows an example of cross-image self attention sharing algorithm according to aspects of the present disclosure.

FIGS. 19 and 20 show examples of methods for image generation according to aspects of the present disclosure.

FIG. 21 shows an example of a method for generating a first attention output through an inner cross-image attention process according to aspects of the present disclosure.

FIG. 22 shows an example of a method for generating a first attention output through an outer cross-image attention process according to aspects of the present disclosure.

FIG. 23 shows an example of a method for training a diffusion model according to aspects of the present disclosure.

FIG. 24 shows an example of a step-by-step procedure for training a machine learning model according to aspects of the present disclosure.

FIG. 25 shows an example of a computing device for image processing according to aspects of the present disclosure.

FIG. 26 shows an example of a transformer network according to aspects of the present disclosure.

### DETAILED DESCRIPTION

The present disclosure describes systems and methods for image generation. Embodiments of the present disclosure include an image generation apparatus that provides a training-free, zero-shot model to generate consistent character images based on a set of text prompts that describe a same object (e.g., “a dog”). By performing a combination of inner cross-image attention process and an outer cross-image attention process, the image generation apparatus ensures that generated characters (of a same object) maintain consistency across multiple synthetic images that are generated based on different prompts (e.g., two or more prompts describing the same object within different scenes).

In the field of digital content generation, large-scale text-to-image (T2I) diffusion models are popular tools. These models can transform textual prompts into imaginative visual scenes, including realistic photographs, vector graphics, and three-dimensional objects within images. However, conventional models often fail to generate consistent portrayal of a same subject across diverse prompts. The aspect of subject consistency is important, particularly in illustration and vector style image generation, due to its wide application in domains such as book illustration, virtual asset design, and graphic novel creation. Conventional models depend on fine-tuning a base model and need multiple pre-existing images of the target character at inference time. This would lead to higher training time and memory consumption. In some cases, as the number of prompts or subjects increases, performance of conventional models is decreased (e.g., cannot maintain subject consistency across multiple synthetic images). In some cases, conventional models focus on modifying the background or style while maintaining subject consistency across prompts. They produce similar images with minimal diversity.

In some embodiments, given a set of textual prompts containing a character (or a subject), an image generation apparatus generates consistent subject in different pose, activity, background and scenarios, e.g., in illustration and vector style. The synthetic images can be used in context of storybook generation, design and advertisement creation. The image generation apparatus, via training free (zero-shot) method, performs consistent subject generation. Accordingly, the quality and diversity of generated images are improved. The training-free model is less memory intensive, has faster runtime, and generalizes well (i.e., can support diverse and multi-subject generations), and the model is not limited to a few prompts.

In some embodiments, an image generation model includes self-attention mechanism using a diffusion model. The self-attention layer is the key for shaping the semantics, structure and layout of the image created by the diffusion model. It handles a series of tokens, each containing features that represent a unique image patch. Each token is transformed through linear projections using three self-attention matrices: W_{q}, Wₖ, and Wᵥ, producing “queries”, “keys”, and “values”, respectively. The self-attention map A_{self} is computed. The self-attention map provides a match score between every pair of patches in the image, guiding the influence of the “Value” features of a target patch on a source patch. The intermediary set of hidden features (denoted as h_{img}) is calculated. These hidden features are then projected using a fourth matrix, the “output-projection” matrix W₀, yielding W₀·h_{img}, which is then combined with the input features x to create the input for the next layer. In some examples, the input for the next layer is computed as:

$${x}_{img}^{′} = {W}_{0} \cdot {h}_{img} + {x}_{img} .$$

The image generation model modifies this self-attention mechanism within the diffusion model, enabling control over the pose, variation, and consistency of characters in the synthesized images.

In some embodiments, the image generation model implements two different types of cross-image attention sharing mechanism in diffusion model and can regulate the extent of attention sharing, thereby addressing concerns related to information leakage, diversity, and variation resulting from inter-image attention sharing. In some examples, the image generation model replaces the standard self-attention mechanism with cross-image self-attention sharing mechanism to generate consistent characters in different poses and backgrounds doing different activities. This process involves the manipulation of the attention mechanism in two distinct ways, referred to as inner cross-image attention and outer cross-image attention. The inner cross-image attention and the outer cross-image attention are further described below.

With regard to inner cross-image attention, the image features are projected into query, key, and value independently. The interaction between key and value is calculated as: K1′=[K1⊕K2⊕ . . . ⊕Kn]; V1′=[V1⊕V2⊕ . . . ⊕Vn]. This is suitable for a sequence of images, represented as I₁, I₂, etc. The attention weights undergo modification by incorporating masks, i.e., M1′=[1⊕M1⊕ . . . ⊕Mn]. The image generation model applies the softmax function A1′=softmax (Q1.K1′^{T}/\sqrt{dk}+log(M1′)). Here, M₁, M₁, . . . , Mₙ represent the subject-relevant masked areas. These are computed by averaging and thresholding the cross-attention maps corresponding to subject tokens across diffusion timesteps and layers. This confines the interaction within subject-relevant areas.

With regard to outer cross-image attention (different from inner cross-image attention sharing), all image features engage in mutual interaction by sharing features within the subject-relevant area. Consider a batch of n image samples, denoted as {I₁, I₂, . . . , Iₙ}. Each image sample is transformed according to I1′=[I1⊕I2*M2⊕ . . . ⊕I2*Mn] to derive a new feature for each sample. Each sample attends to all its tokens and the subject-area masked on others. The shared features subsequently undergo a linear projection to generate query (Q), key (K), and value (V). The attention is then calculated as per equation

$${A}_{self} = softmax ( {Q}_{img} \cdot {K}_{img}^{T} / \sqrt{{d}_{k}} ) .$$

In some embodiments, the image generation model applies selective cross-image attention injection. Attention layers in the diffusion model are important for controlling image layout and correlation with the input prompt. Intuitively performing cross-image attention sharing on all layers and among all denoising steps may result in all consistent images that are nearly the same. In some examples, the image generation model applies selective cross-image attention injection taking into account the impact of modifying self-attention maps at various stages and layers within the diffusion model. Based on example experiments, it is observed that the query features in the shallow layers of a U-Net (e.g., encoder part) may not obtain clear layout and structure corresponding to the prompt.

Accordingly, the image generation model is configured to limit attention sharing to the decoder layers of the U-Net. However, preserving noise vector alignment in subject relevant area, even when the subject is not clearly defined, is important for future layer formation. It is shown that the sharing of inner cross-image attention is beneficial during the initial, noisy stages of diffusion timesteps. This process aids in aligning image features by distributing keys and values across images. This alignment is important for effective sharing in subsequent layers, leading to consistent subject formation. After the 15th iteration, once the subject layout starts becoming visible, the image generation model employs outer cross-image attention sharing. This method aligns spatial features, produces coherent textures, and ensures a harmonious variation in color. To mitigate overfitting and disruption in the desired spatial layout, in some examples, the image generation model skips cross-image attention sharing in the first five steps of the consistent image generation process. Additionally, outer cross-image attention mechanism is less computationally intensive, facilitating consistent subject generation for larger prompt batches.

In some examples, the layout remains undefined during initial timesteps of image generation from diffusion models. Thus, the generation of masks through thresholding cross-attention maps pertinent to the subject token often results in imperfections. To ensure generalization and prevent information leakage across the background of consistent images, an element of randomness is introduced. This strategy employs a Bernoulli distribution, represented as mᵢ˜Bernoulli(p). This process introduces randomness into the masks, to prevent information leakage in background area, by transforming some of the 1's into 0's with a probability p. In some examples, p is set to 0.7 in the context of diffusion model.

The process of text-guided image generation is impacted by the noise scheduling functions present in diffusion denoising models. The image generation model described in the present disclosure increases image quality by removing the appearance of artifacts in the generated images. In some examples, a log signal-to-noise ratio (log SNR) function is used for inference timestep sampling of the diffusion model to eliminate artifacts and increase image quality. Different from a uniform noise schedule function, the log SNR noise schedule function for the U-Net during the inference time is used because log SNR schedule function samples dense timesteps when close to the final image. This ensures that no artifacts should appear at the end of the denoising process.

In some examples, the image generation model applies consolidation of subject masks through a union operation after thresholding. This method facilitates the generation of multi-subject consistent outputs. Despite the semantic diversity inherent in subjects, this method is based on the exponential nature of attention softmax, acting as a natural gate to prevent information leakage between unrelated subjects. Furthermore, the integration of a thresholding mechanism within the feature injection process enhances this gate, reducing information leakage. Accordingly, embodiments improve the text-to-image generation process by increasing fidelity and coherence across a wide spectrum of subject variations.

The present disclosure describes systems and methods that improve on conventional image generation models by increasing the accuracy of generated objects within different scenes using a combination of inner cross-image attention process and outer cross-image attention process. For example, users can use the image generation model described in the present disclosure to generate a set of synthetic images based on a set of prompts, where the synthetic images depict a same object which has consistency in identity and appearance, while the object looks different in pose, expression and is located within different scenes specified by the prompts. Embodiments of the present disclosure achieve this improved accuracy by enabling feature sharing among key vectors and value vectors (inner cross-image attention) and image feature sharing (outer cross-image attention). Additionally, the image generation model performs selective cross-image attention injection by restricting attention sharing to decoder layers of a U-Net. Accordingly, the quality of synthetic images improved (e.g., consistency in identity and appearance of a target object, clear layout and structure).

In some embodiments, the proposed training-free, zero shot method of inner and outer cross-image self-attention sharing demonstrates ability to generate consistent characters across a diverse range of objects, scenarios and styles. Embodiments of the present disclosure are not dependent on text tokens the model has been trained on, additional images for test-time fine-tuning. The image generation model can generate characters in different poses while maintaining consistency in identity and appearance. The image generation model achieves high fidelity and visually appealing images, while maintaining consistency, layout diversity, and variations.

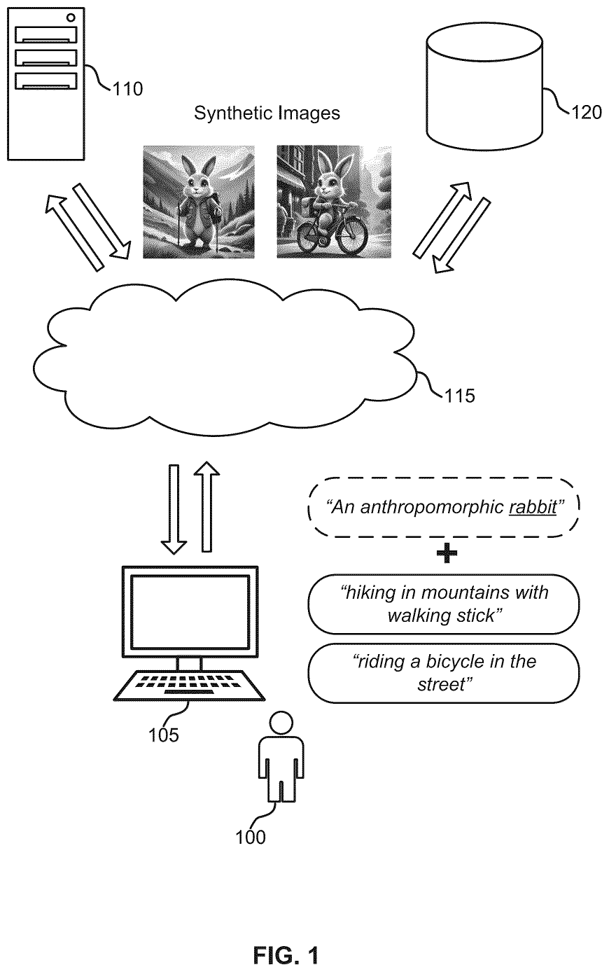

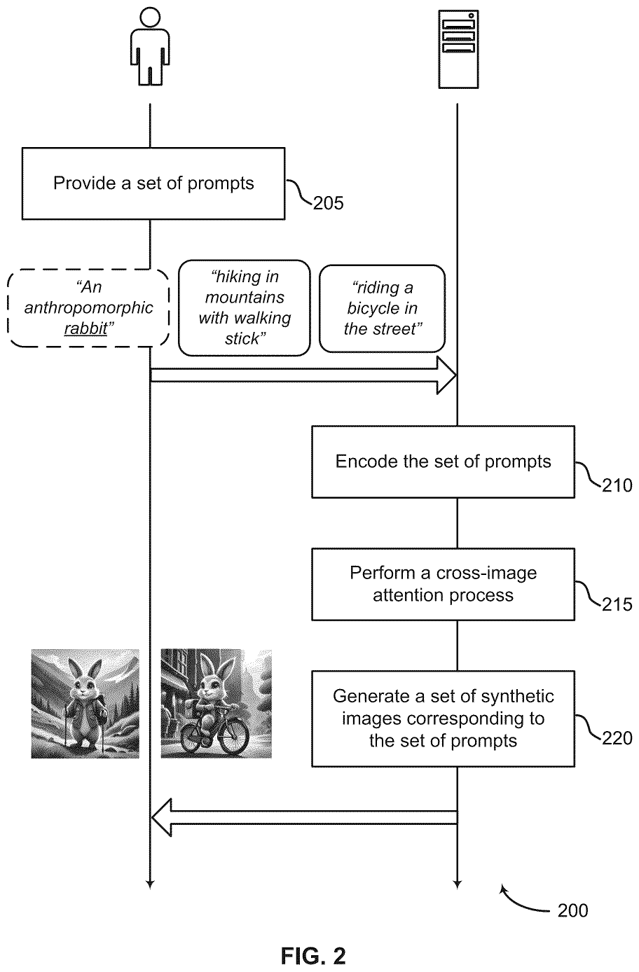

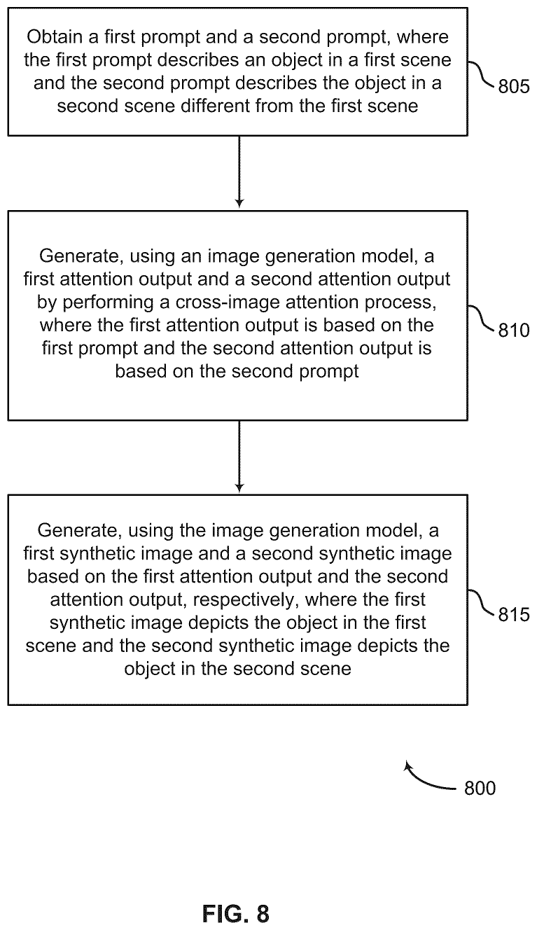

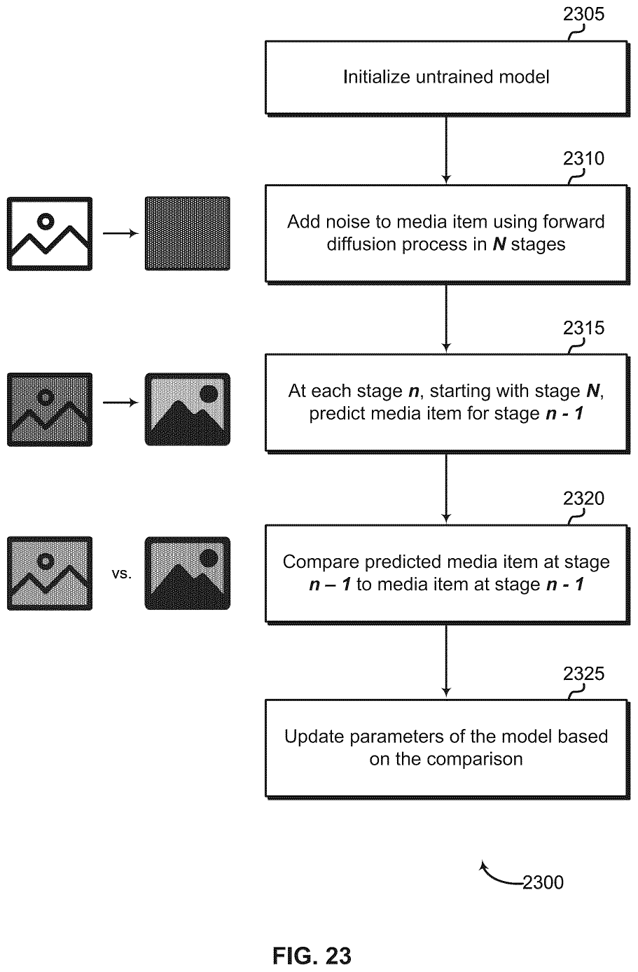

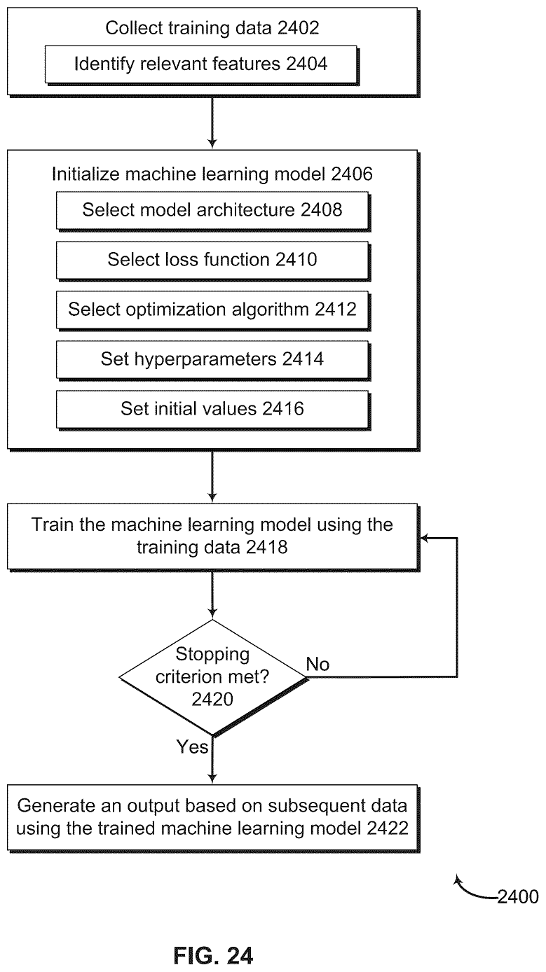

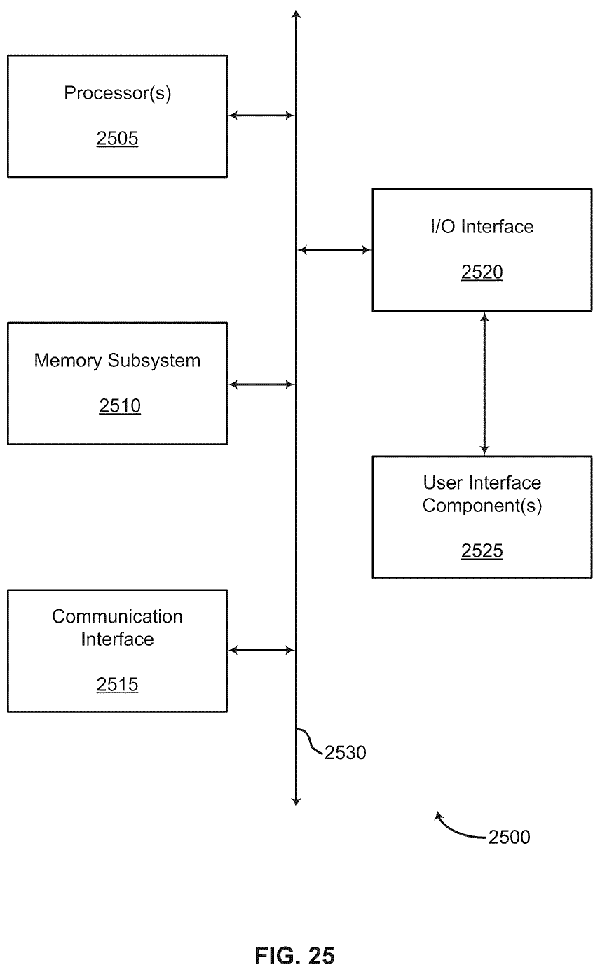

Methods, apparatus, systems of the present disclosure can be applied in the field of consistent image generation from text prompts. The image generation model generates multiple consistent characters in images and can be used for creation of animated stories, as an example. Examples of application in image generation context are provided with reference to FIGS. 2-7. Details regarding the architecture of an example image generation system are provided with reference to FIGS. 1 and 9-17. Details regarding the consistent character image generation process are provided with reference to FIGS. 8 and 18-22. Details regarding an example of training a machine learning model are provided with reference to FIGS. 23-24. Details regarding a computing device for image generation are provided with reference to FIG. 25.

### Image Generation

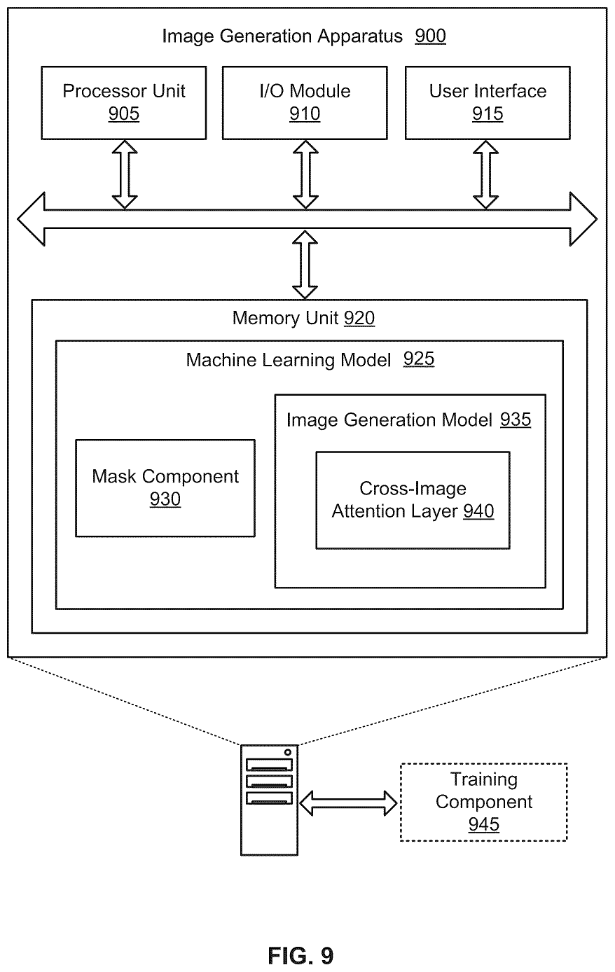

FIG. 1 shows an example of an image generation system according to aspects of the present disclosure. The example shown includes user 100, user device 105, image generation apparatus 110, cloud 115, and database 120. Image generation apparatus 110 is an example of, or includes aspects of, the corresponding element described with reference to FIG. 9.

In an example shown in FIG. 1, an object prompt is provided by user 100. For example, the object prompt is “An anthropomorphic rabbit” which describes an object “rabbit”. A first scene prompt and a second scene prompt are provided by user 100. The first scene prompt is “hiking in mountains with walking stick” and the second scene prompt is “riding a bicycle in the street”. The object prompt and the first scene prompt are combined to obtain a first prompt. The object prompt and the second scene prompt are combined to obtain a second prompt. The first prompt and the second prompt are transmitted to image generation apparatus 110, e.g., via user device 105 and cloud 115.

Image generation apparatus 110 generates a first attention output and a second attention output by performing a cross-image attention process, where the first attention output is based on the first prompt and the second prompt, and the second attention output is based on the first prompt and the second prompt. Image generation apparatus 110 generates a first synthetic image and a second synthetic image based on the first attention output and the second attention output, respectively. The first synthetic image depicts the object in the first scene and the second synthetic image depicts the object in the second scene. Image generation apparatus 110 returns the first synthetic image and the second synthetic image to user 100 via cloud 115 and user device 105.

User device 105 may be a personal computer, laptop computer, mainframe computer, palmtop computer, personal assistant, mobile device, or any other suitable processing apparatus. In some examples, user device 105 includes software that incorporates an image processing application (e.g., an image generator, an image editing tool). In some examples, the image processing application on user device 105 may include functions of image generation apparatus 110.

A user interface may enable user 100 to interact with user device 105. In some embodiments, the user interface may include an audio device, such as an external speaker system, an external display device such as a display screen, or an input device (e.g., a remote-control device interfaced with the user interface directly or through an I/O controller module). In some cases, a user interface may be a graphical user interface (GUI). In some examples, a user interface may be represented in code which is sent to the user device 105 and rendered locally by a browser.

Image generation apparatus 110 includes a computer-implemented network comprising a mask component and an image generation model. Image generation apparatus 110 may also include a processor unit, a memory unit, an I/O module, and a user interface. A training component may be implemented on an apparatus other than image generation apparatus 110. The training component is used to train a machine learning model. Additionally, image generation apparatus 110 can communicate with database 120 via cloud 115. In some cases, the architecture of the image generation network is also referred to as a network, a machine learning model, or a network model. Further detail regarding the architecture of image generation apparatus 110 is provided with reference to FIGS. 9-17. Further detail regarding the operation of image generation apparatus 110 is provided with reference to FIGS. 2, 8 and 18-22.

In some cases, image generation apparatus 110 is implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a supercomputer, or any other suitable processing apparatus.

Cloud 115 is a computer network configured to provide on-demand availability of computer system resources, such as data storage and computing power. In some examples, cloud 115 provides resources without active management by the user. The term “cloud” is sometimes used to describe data centers available to many users over the Internet. Some large cloud networks have functions distributed over multiple locations from central servers. A server is designated an edge server if it has a direct or close connection to a user. In some cases, cloud 115 is limited to a single organization. In other examples, cloud 115 is available to many organizations. In one example, cloud 115 includes a multi-layer communications network comprising multiple edge routers and core routers. In another example, cloud 115 is based on a local collection of switches in a single physical location.

Database 120 is an organized collection of data. For example, database 120 stores data (e.g., dataset for training a diffusion model) in a specified format known as a schema. Database 120 may be structured as a single database, a distributed database, multiple distributed databases, or an emergency backup database. In some cases, a database controller may manage data storage and processing in database 120. In some cases, a user interacts with the database controller. In other cases, database controllers may operate automatically without user interaction.

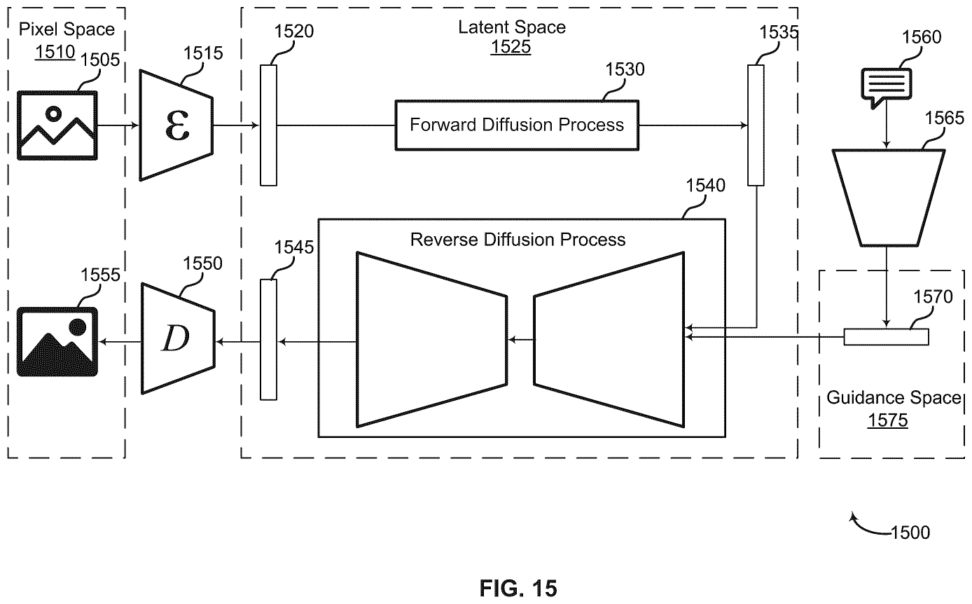

FIG. 2 shows an example of a method 200 conditional media generation according to aspects of the present disclosure. In some examples, method 200 describes an operation of the machine learning model 925 described with reference to FIG. 9 such as an application of the guided latent diffusion model 1500 described with reference to FIG. 15. In some examples, these operations are performed by a system including a processor executing a set of codes to control functional elements of an apparatus such as the image generation apparatus described in FIGS. 1 and 9.

Additionally or alternatively, steps of the method 200 may be performed using special-purpose hardware. Generally, these operations are performed according to the methods and processes described in accordance with aspects of the present disclosure. In some cases, the operations described herein are composed of various substeps or are performed in conjunction with other operations.

At operation 205, the user provides a set of prompts. In some cases, the operations of this step refer to, or may be performed by, a user as described with reference to FIG. 1. The user may provide an object prompt (e.g., “an anthropomorphic rabbit”), a first scene prompt (e.g., “hiking in mountains with walking stick”) and a second scene prompt (e.g., “riding a bicycle in the street”). The object prompt and the first scene prompt (e.g., “hiking in mountains with walking stick”) are combined to obtain a first prompt. The object prompt and the second scene prompt are combined to obtain a second prompt.

At operation 210, the system encodes the set of prompts. In some cases, the operations of this step refer to, or may be performed by, an image generation apparatus as described with reference to FIGS. 1 and 9.

At operation 215, the system performs a cross-image attention process. In some cases, the operations of this step refer to, or may be performed by, an image generation apparatus as described with reference to FIGS. 1 and 9.

At operation 220, the system generates a set of synthetic images corresponding to the set of prompts, respectively. In some cases, the operations of this step refer to, or may be performed by, an image generation apparatus as described with reference to FIGS. 1 and 9. In an embodiment, an image generation apparatus (with reference to FIGS. 1 and 9) generates a first synthesized image and a second synthesized image based on the first prompt and the second prompt, respectively.

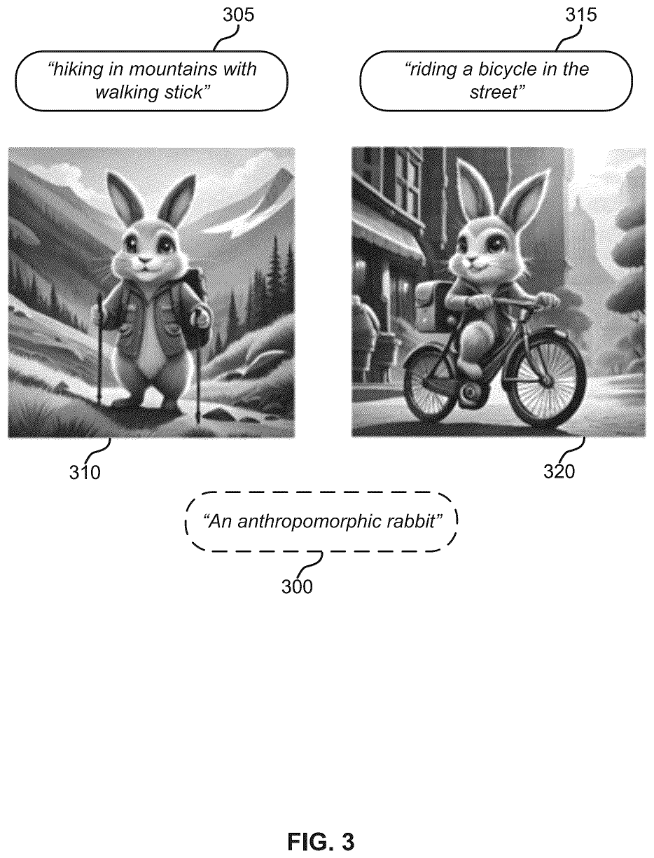

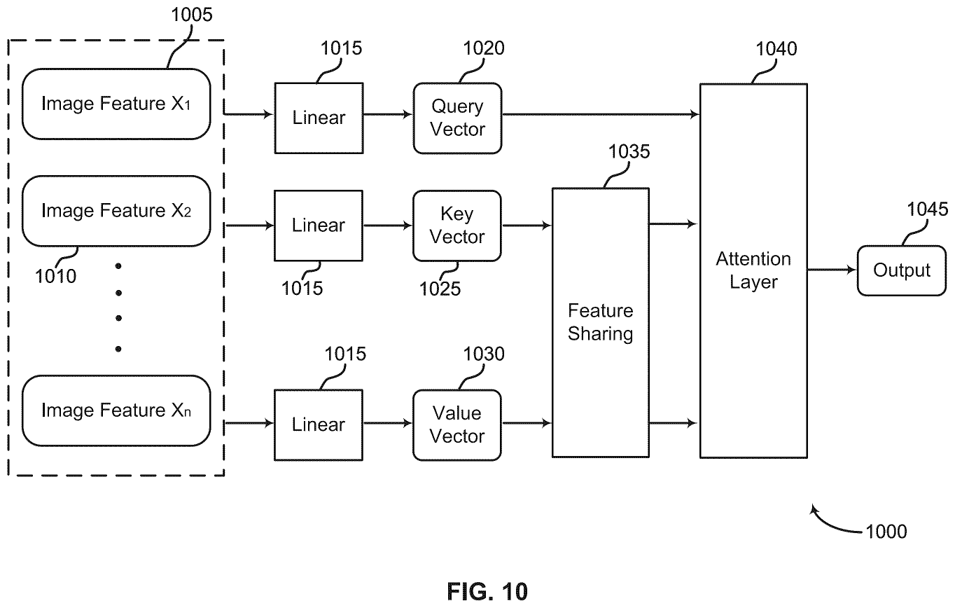

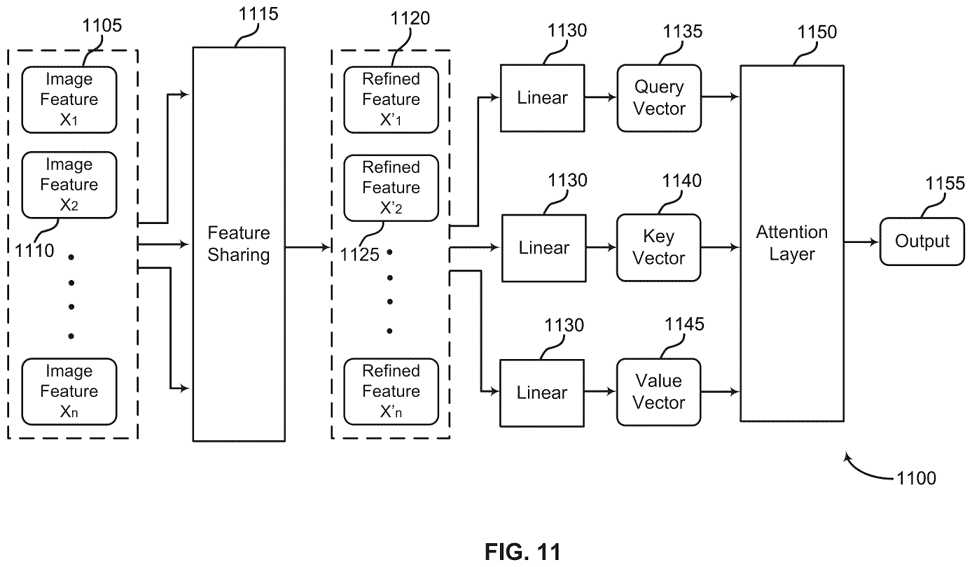

In some embodiments, an image generation model generates a first synthetic image and a second synthetic image based on a first attention output and a second attention output, respectively, where the first synthetic image depicts the object in the first scene and the second synthetic image depicts the object in the second scene. FIGS. 3-7 show examples of multiple images generated with a consistent object displayed in multiple different scenes. FIGS. 10 and 11 show how the first attention output (and the second attention output) are generated based on shared features representing multiple prompts including a first prompt and a second prompt.

The first attention output may represent a first synthetic image while the second attention output represents a second synthetic image. In another example, the model receives three prompts from a user (a first prompt, a second prompt, a third prompt). The model initiates three random noise seeds and simultaneously shares image features between the three prompts through a combination of cross-image attention and outer cross-image attention.

FIG. 3 shows an example of consistent subject generation with two prompts according to aspects of the present disclosure. The example shown includes object prompt 300, first scene prompt 305, first synthetic image 310, second scene prompt 315, and second synthetic image 320.

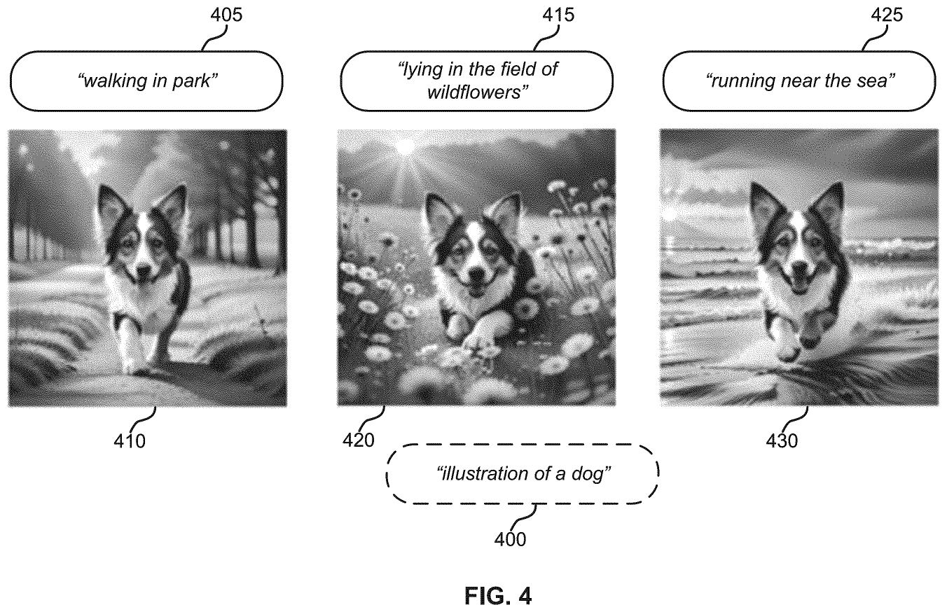

In some examples, a user provides object prompt 300 “an anthropomorphic rabbit” which includes an element of a rabbit (i.e., an object). Object prompt 300 is an example of, or includes aspects of, the corresponding element described with reference to FIGS. 4, 6, and 7.

The user provides first scene prompt 305 “hiking in mountains with walking stick” which describes a first scene for the rabbit object. First scene prompt 305 is an example of, or includes aspects of, the corresponding element described with reference to FIGS. 4, 6, and 7.

In some examples, the user provides second scene prompt 315 “riding a bicycle in the street” which describes a second scene for the rabbit object. Second scene prompt 315 is an example of, or includes aspects of, the corresponding element described with reference to FIGS. 4, 6, and 7.

In some examples, object prompt 300 and first scene prompt 305 are combined to obtain a first prompt (“an anthropomorphic rabbit hiking in mountains with walking stick”). The first prompt is input to machine learning model 925 described with reference to FIG. 9. Machine learning model 925 generates, using an image generation model, a first synthetic image 310 based on the first prompt. First synthetic image 310 is an example of, or includes aspects of, the corresponding element described with reference to FIGS. 4-7, and 14.

In some examples, object prompt 300 and second scene prompt 315 are combined to obtain a second prompt (“an anthropomorphic rabbit riding a bicycle in the street”). The first prompt is input to machine learning model 925, which generates, using the image generation model, a second synthetic image 320 based on the second prompt. Second synthetic image 320 is an example of, or includes aspects of, the corresponding element described with reference to FIGS. 4-7, and 14.

FIG. 4 shows an example of consistent subject generation with three prompts according to aspects of the present disclosure. The example shown includes object prompt 400, first scene prompt 405, first synthetic image 410, second scene prompt 415, second synthetic image 420, third scene prompt 425, and third synthetic image 430.

In some examples, a user provides an object prompt 400 “illustration of a dog” which includes a target element, i.e., a dog object. The user provides a first scene prompt 405 “walking in park” which describes a first scene for the dog object. The object prompt 400 and the first scene prompt 405 are combined to obtain a first prompt (“illustration of a dog walking in park”). The first prompt is input to machine learning model 925 as described with reference to FIG. 9. Machine learning model 925 generates, using an image generation model, first synthetic image 410 based on the first prompt. First synthetic image 410 is an example of, or includes aspects of, the corresponding element described with reference to FIGS. 3, 5-7, and 14.

The user provides a second scene prompt 415 “lying in the field of wildflowers” which describes a second scene for the dog object. The object prompt 400 and the second scene prompt 415 are combined to obtain a second prompt (“illustration of a dog lying in the field of wildflowers”). The second prompt is input to machine learning model 925 which generates, using the image generation model, second synthetic image 420 based on the second prompt. Second synthetic image 420 is an example of, or includes aspects of, the corresponding element described with reference to FIGS. 3, 5-7, and 14.

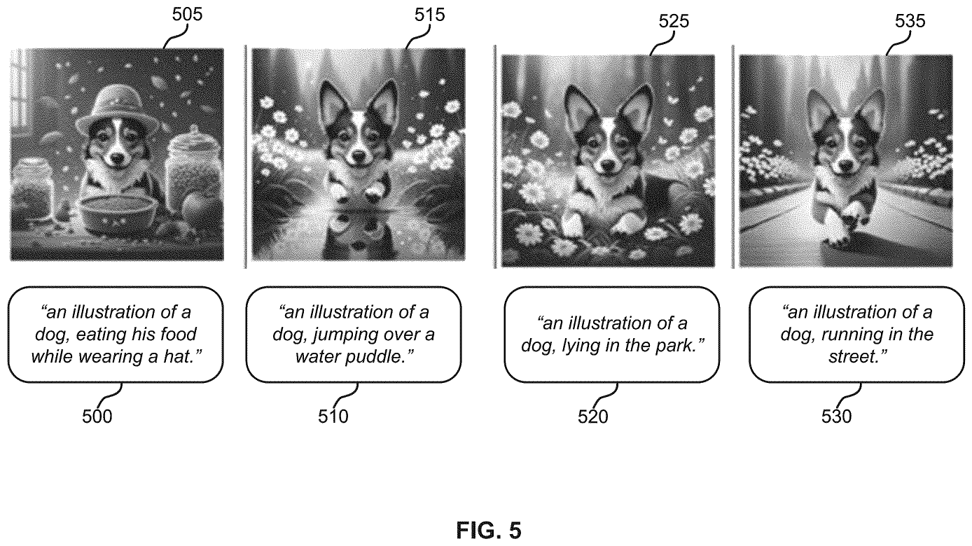

The user provides a third scene prompt 425 “running near the sea” which describes a second scene for the dog object. The object prompt 400 and the third scene prompt 425 are combined to obtain a third prompt (“illustration of a dog running near the sea”). The third prompt is input to machine learning model 925 which generates, using the image generation model, third synthetic image 430 based on the third prompt. Third synthetic image 430 is an example of, or includes aspects of, the corresponding element described with reference to FIGS. 5-7, and 14.

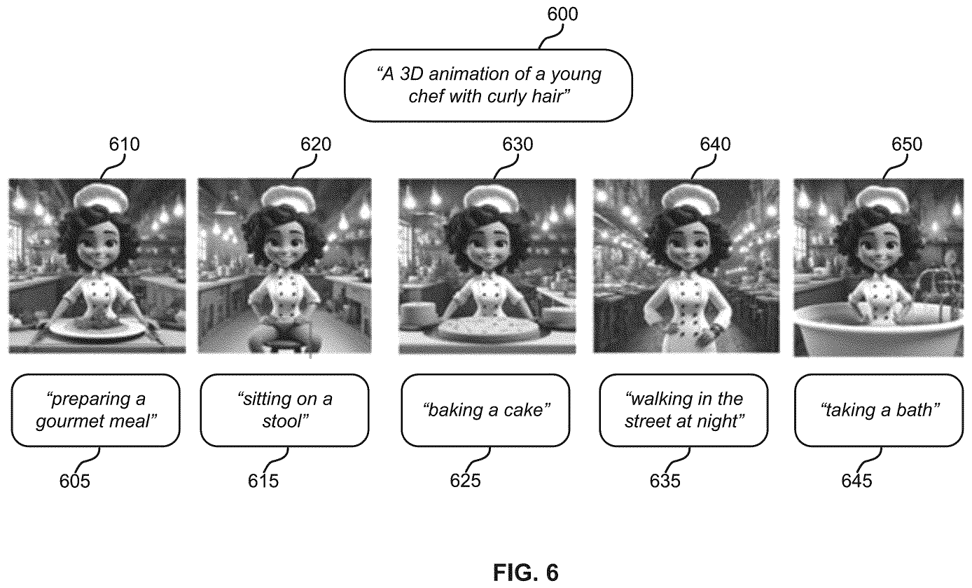

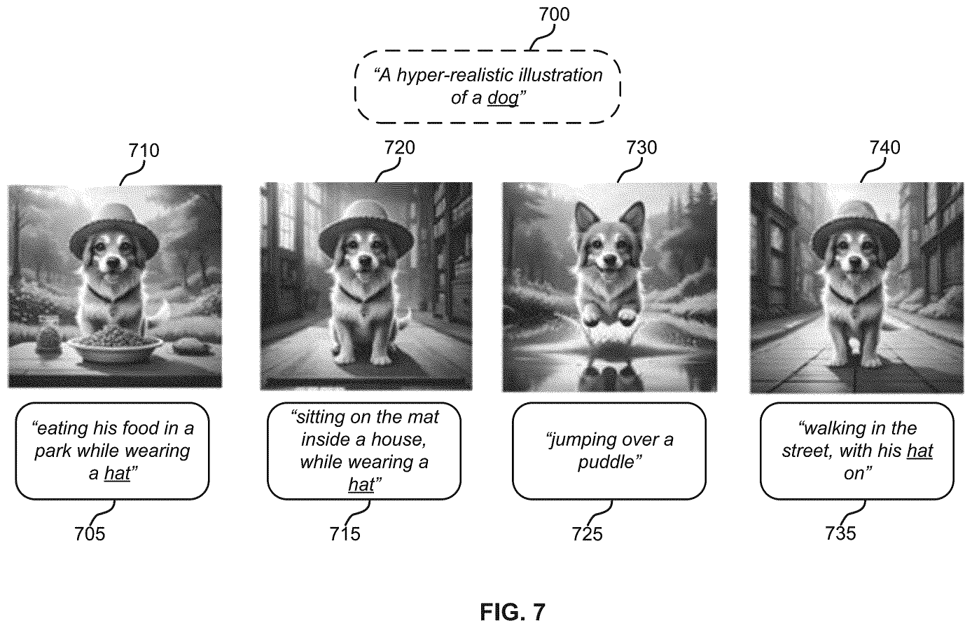

Object prompt 400 is an example of, or includes aspects of, the corresponding element described with reference to FIGS. 3, 6, and 7. First scene prompt 405 is an example of, or includes aspects of, the corresponding element described with reference to FIGS. 3, 6, and 7. Second scene prompt 415 is an example of, or includes aspects of, the corresponding element described with reference to FIGS. 3, 6, and 7. Third scene prompt 425 is an example of, or includes aspects of, the corresponding element described with reference to FIGS. 6 and 7.

FIG. 5 shows an example of consistent subject generation with four prompts according to aspects of the present disclosure. The example shown includes first prompt 500, first synthetic image 505, second prompt 510, second synthetic image 515, third prompt 520, third synthetic image 525, fourth prompt 530, and fourth synthetic image 535.

In some examples, a user provides a first prompt 500 “an illustration of a dog, eating his food while wearing a hat.” Machine learning model 925 as described in FIG. 9 generates first synthetic image 505 that depicts a dog in a first scene as described in first prompt 500.

The user provides a second prompt 510 “an illustration of a dog, jumping over a water puddle.” Machine learning model 925 generates a second synthetic image 515 that depicts the same object (i.e., the dog) in a second scene as described in the second prompt 510.

The user provides a third prompt 520 “an illustration of a dog, laying in the park.” Machine learning model 925 generates a third synthetic image 525 that depicts the same object (i.e., the dog) in a third scene as described in the third prompt 520.

The user provides a fourth prompt 530 “an illustration of a dog, running in the street.” Machine learning model 925 generates a fourth synthetic image 535 that depicts the same object (i.e., the dog) in a fourth scene as described in the fourth prompt 530.

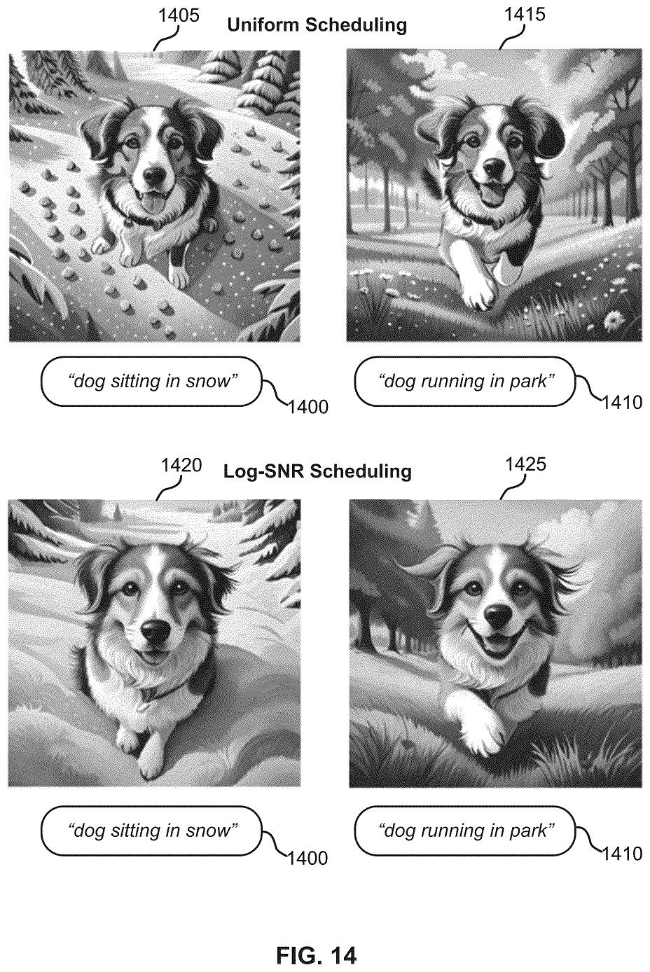

First prompt 500 is an example of, or includes aspects of, the corresponding element described with reference to FIG. 14. First synthetic image 505 is an example of, or includes aspects of, the corresponding element described with reference to FIGS. 3, 4, 6, 7, and 14.

Second prompt 510 is an example of, or includes aspects of, the corresponding element described with reference to FIG. 14. Second synthetic image 515 is an example of, or includes aspects of, the corresponding element described with reference to FIGS. 3, 4, 6, 7, and 14.

Third synthetic image 525 is an example of, or includes aspects of, the corresponding element described with reference to FIGS. 4, 6, 7, and 14. Fourth synthetic image 535 is an example of, or includes aspects of, the corresponding element described with reference to FIGS. 6, 7, and 14.

FIG. 6 shows an example of consistent subject generation with five prompts according to aspects of the present disclosure. The example shown includes object prompt 600, first scene prompt 605, first synthetic image 610, second scene prompt 615, second synthetic image 620, third scene prompt 625, third synthetic image 630, fourth scene prompt 635, fourth synthetic image 640, fifth scene prompt 645, and fifth synthetic image 650.

In some examples, a user provides an object prompt “A 3D animation of a young chef with curly hair” which describes an object (e.g., a young chef). The object prompt 600 and a first scene prompt 605 (“preparing a gourmet meal”) are combined to obtain a first prompt. The machine learning model 925 described in FIG. 9 generates first synthetic image 610 based on the first prompt (“A 3D animation of a young chef with curly hair preparing a gourmet meal”). Object prompt 600 is an example of, or includes aspects of, the corresponding element described with reference to FIGS. 3, 4, and 7.

The object prompt 600 and a second scene prompt 615 (“sitting on a stool”) are combined to obtain a second prompt. The machine learning model 925 generates second synthetic image 620 based on the second prompt (“A 3D animation of a young chef with curly hair sitting on a stool”).

The object prompt 600 and a third scene prompt 625 (“baking a cake”) are combined to obtain a third prompt. The machine learning model 925 generates third synthetic image 630 based on the third prompt (“A 3D animation of a young chef with curly hair baking a cake”).

The object prompt 600 and a fourth scene prompt 635 (“walking in the street at night”) are combined to obtain a fourth prompt. The machine learning model 925 generates fourth synthetic image 640 based on the fourth prompt (“A 3D animation of a young chef with curly hair walking in the street at night”).

The object prompt 600 and a fifth scene prompt 645 (“taking a bath”) are combined to obtain a fifth prompt. The machine learning model 925 generates fifth synthetic image 650 based on the fifth prompt (“A 3D animation of a young chef with curly hair taking a bath”).

First scene prompt 605 is an example of, or includes aspects of, the corresponding element described with reference to FIGS. 3, 4, and 7. First synthetic image 610 is an example of, or includes aspects of, the corresponding element described with reference to FIGS. 3-5, 7, and 14.

Second scene prompt 615 is an example of, or includes aspects of, the corresponding element described with reference to FIGS. 3, 4, and 7. Second synthetic image 620 is an example of, or includes aspects of, the corresponding element described with reference to FIGS. 3-5, 7, and 14.

Third scene prompt 625 is an example of, or includes aspects of, the corresponding element described with reference to FIGS. 4 and 7. Third synthetic image 630 is an example of, or includes aspects of, the corresponding element described with reference to FIGS. 4, 5, 7, and 14.

Fourth scene prompt 635 is an example of, or includes aspects of, the corresponding element described with reference to FIG. 7. Fourth synthetic image 640 is an example of, or includes aspects of, the corresponding element described with reference to FIGS. 5, 7, and 14.

FIG. 7 shows an example of multi-subject prompt to image generation according to aspects of the present disclosure. The example shown includes object prompt 700, first scene prompt 705, first synthetic image 710, second scene prompt 715, second synthetic image 720, third scene prompt 725, third synthetic image 730, fourth scene prompt 735, and fourth synthetic image 740.

In some examples, a user provides an object prompt 700 “a hyper-realistic illustration of a dog”. The object prompt 700 and first scene prompt 705 (“eating his food in a park while wearing a hat”) are combined to obtain a first prompt “a hyper-realistic illustration of a dog eating his food in a park while wearing a hat”. Here, the object “hat” in first scene prompt 705 is an additional object besides “dog” in object prompt 700. Object prompt 700 is an example of, or includes aspects of, the corresponding element described with reference to FIGS. 3, 4, and 6.

The object prompt 700 and second scene prompt 715 (“sitting on the mat inside a house, while wearing a hat”) are combined to obtain a second prompt “a hyper-realistic illustration of a dog sitting on the mat inside a house, while wearing a hat”. Here, the object “hat” in second scene prompt 715 is an additional object besides “dog” in object prompt 700.

The object prompt 700 and third scene prompt 725 (“jumping over a puddle”) are combined to obtain a third prompt “a hyper-realistic illustration of a dog jumping over a puddle”.

The object prompt 700 and fourth scene prompt 735 (“walking in the street, with his hat on”) are combined to obtain a fourth prompt “a hyper-realistic illustration of a dog walking in the street, with his hat on”. Here, the object “hat” in first scene prompt 705 is an additional object besides “dog” in object prompt 700.

The machine learning model 925 described in FIG. 9 generates first synthetic image 710, second synthetic image 720, third synthetic image 730, and fourth synthetic image 740 based on the first prompt, the second prompt, the third prompt, and the fourth prompt, respectively.

In an embodiment, machine learning model 925 incorporates consolidation of subject masks through a simple union operation after thresholding. This addition facilitates the generation of multi-subject consistent outputs (shown in FIG. 7, multiple subjects include “dog” and “hat”). Despite the semantic diversity inherent in subjects, machine learning model 925 ensures efficacy by leveraging the exponential nature of attention softmax, acting as a natural gate to prevent information leakage between unrelated subjects. Furthermore, the integration of a thresholding mechanism within the feature injection process enhances this gate, bolstering resilience against potential information leakage. Collectively, these techniques optimize the generation process, increasing fidelity and coherence across a wide spectrum of subject variations.

First scene prompt 705 is an example of, or includes aspects of, the corresponding element described with reference to FIGS. 3, 4, and 6. First synthetic image 710 is an example of, or includes aspects of, the corresponding element described with reference to FIGS. 3-6, and 14.

Second scene prompt 715 is an example of, or includes aspects of, the corresponding element described with reference to FIGS. 3, 4, and 6. Second synthetic image 720 is an example of, or includes aspects of, the corresponding element described with reference to FIGS. 3-6, and 14.

Third scene prompt 725 is an example of, or includes aspects of, the corresponding element described with reference to FIGS. 4 and 6. Third synthetic image 730 is an example of, or includes aspects of, the corresponding element described with reference to FIGS. 4-6, and 14.

Fourth scene prompt 735 is an example of, or includes aspects of, the corresponding element described with reference to FIG. 6. Fourth synthetic image 740 is an example of, or includes aspects of, the corresponding element described with reference to FIGS. 5, 6, and 14.

FIG. 8 shows an example of a method 800 for image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 805, the system obtains a first prompt and a second prompt, where the first prompt describes an object in a first scene and the second prompt describes the object in a second scene different from the first scene. In some cases, the operations of this step refer to, or may be performed by, a machine learning model as described with reference to FIG. 9.

At operation 810, the system generates, using an image generation model, a first attention output and a second attention output by performing a cross-image attention process, where the first attention output is based on the first prompt and the second prompt, and where the second attention output is based on the first prompt and the second prompt. In some cases, the operations of this step refer to, or may be performed by, an image generation model as described with reference to FIG. 9.

For example, with reference to FIG. 3, the image generation model obtains a first scene prompt “hiking in mountains with walking stick” describing an object (“an anthropomorphic rabbit”) in a first scene and a second scene prompt (“riding a bicycle in the street”) describing the same object (“An anthropomorphic rabbit”) in a second scene.

At operation 815, the system generates, using the image generation model, a first synthetic image and a second synthetic image based on the first attention output and the second attention output, respectively, where the first synthetic image depicts the object in the first scene and the second synthetic image depicts the object in the second scene. In some cases, the operations of this step refer to, or may be performed by, an image generation model as described with reference to FIG. 9.

Referring to the example in FIG. 3, the image generation model generates a set of synthetic images (e.g., 2 images, 3 images, 4 images, 5 images) depicting a same object within different scenes. The first synthetic image depicts an anthropomorphic rabbit, in a mountain hiking scene. The second synthetic image depicts the same rabbit in a bicycle riding/street scene. The same object may show different poses, orientations, views, facial expressions, body movements in the set of synthetic images.

In FIGS. 1-8, a method, apparatus, non-transitory computer readable medium, and system for image generation are described. One or more embodiments of the method, apparatus, non-transitory computer readable medium, and system include obtaining a first prompt and a second prompt, wherein the first prompt describes an object in a first scene and the second prompt describes the object in a second scene different from the first scene; generating, using an image generation model, a first attention output and a second attention output by performing a cross-image attention process, wherein the first attention output is based on the first prompt and the second prompt, and wherein the second attention output is based on the first prompt and the second prompt; and generating, using the image generation model, a first synthetic image and a second synthetic image based on the first attention output and the second attention output, respectively, wherein the first synthetic image depicts the object in the first scene and the second synthetic image depicts the object in the second scene.

Some examples of the method, apparatus, non-transitory computer readable medium, and system further include obtaining an object prompt, a first scene prompt, and a second scene prompt. Some examples further include combining the object prompt and the first scene prompt to obtain the first prompt. Some examples further include combining the object prompt and the second scene prompt to obtain the second prompt.

Some examples of the method, apparatus, non-transitory computer readable medium, and system further include generating a first mask corresponding to a location of the object in the first scene. Some examples further include generating a second mask corresponding to a location of the object in the second scene, wherein the first attention output is based on the first mask and the second mask.

Some examples of the method, apparatus, non-transitory computer readable medium, and system further include determining a probability value. Some examples further include randomly modifying one or more pixels of the first mask based on the probability value.

Some examples of the method, apparatus, non-transitory computer readable medium, and system further include generating first image features based on the first prompt and second image features based on the second prompt. Some examples further include computing a first key vector and a first value vector based on the first image features. Some examples further include computing a second key vector and a second value vector based on the second image features. Some examples further include generating a combined key vector based on the first key vector and the second key vector. Some examples further include generating a combined value vector based on the first value vector and the second value vector, wherein the first attention output is based on the combined key vector and the combined value vector.

Some examples of the method, apparatus, non-transitory computer readable medium, and system further include generating first image features based on the first prompt and second image features based on the second prompt. Some examples further include computing combined image features based on the first image features and the second image features. Some examples further include computing a query vector, a key vector, and a value vector based on the combined image features, wherein the first attention output is based on the query vector, the key vector, and the value vector.

Some examples of the method, apparatus, non-transitory computer readable medium, and system further include generating, using the image generation model, a third attention output by performing a subsequent cross-image attention process different from the cross-image attention process, wherein the cross-image attention process is performed at a first timestep and the subsequent cross-image attention process is performed at a second timestep following the first timestep, and wherein the first synthetic image is based on the third attention output.

In some examples, the cross-image attention process comprises an inner cross-image attention process, and wherein the subsequent cross-image attention process comprises an outer cross-image attention process. Some examples of the method, apparatus, non-transitory computer readable medium, and system further include obtaining a noise input. Some examples further include denoising the noise input based on the first prompt and the first attention output. Some examples of the method, apparatus, non-transitory computer readable medium, and system further include selecting a denoising schedule based on a log signal-to-noise ratio (log SNR) function.

### Network Architecture

FIG. 9 shows an example of an image generation apparatus 900 according to aspects of the present disclosure. The example shown includes image generation apparatus 900, processor unit 905, I/O module 910, user interface 915, memory unit 920, machine learning model 925, and training component 945. Image generation apparatus 900 is an example of, or includes aspects of, the corresponding element described with reference to FIG. 1.

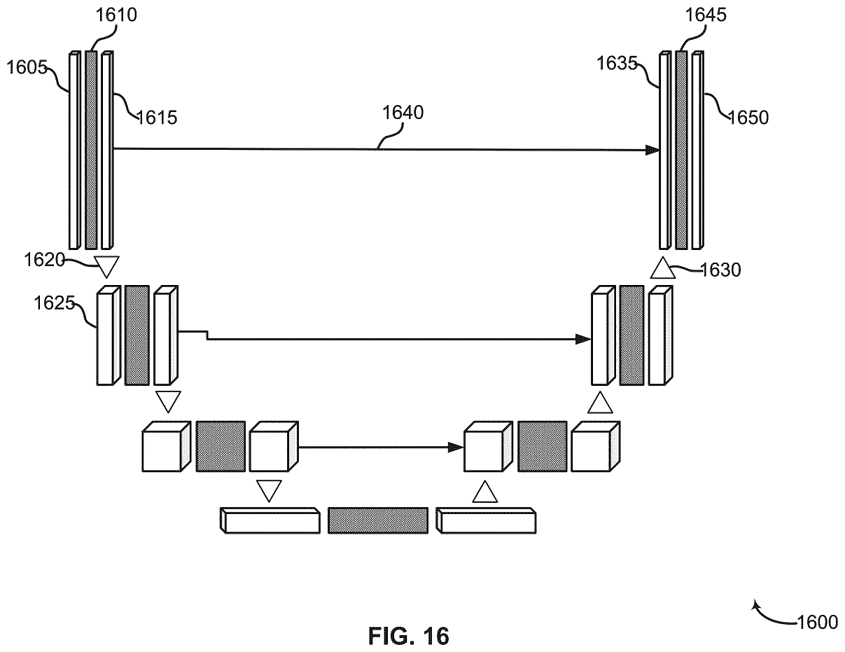

Image generation apparatus 900 may include an example of, or aspects of, the guided diffusion model described with reference to FIG. 15 and the U-Net described with reference to FIG. 16. In some embodiments, image generation apparatus 900 includes processor unit 905, I/O module 910, user interface 915, memory unit 920, machine learning model 925, and training component 945. Training component 945 updates parameters of the machine learning model 925 stored in memory unit 920. In some examples, the training component 945 is located outside the image generation apparatus 900.

Processor unit 905 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 905 is configured to operate a memory array using a memory controller. In other cases, a memory controller is integrated into processor unit 905. In some cases, processor unit 905 is configured to execute computer-readable instructions stored in memory unit 920 to perform various functions. In some aspects, processor unit 905 includes special purpose components for modem processing, baseband processing, digital signal processing, or transmission processing. According to some aspects, processor unit 905 comprises one or more processors described with reference to FIG. 25.

Memory unit 920 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 905 to perform various functions described herein.

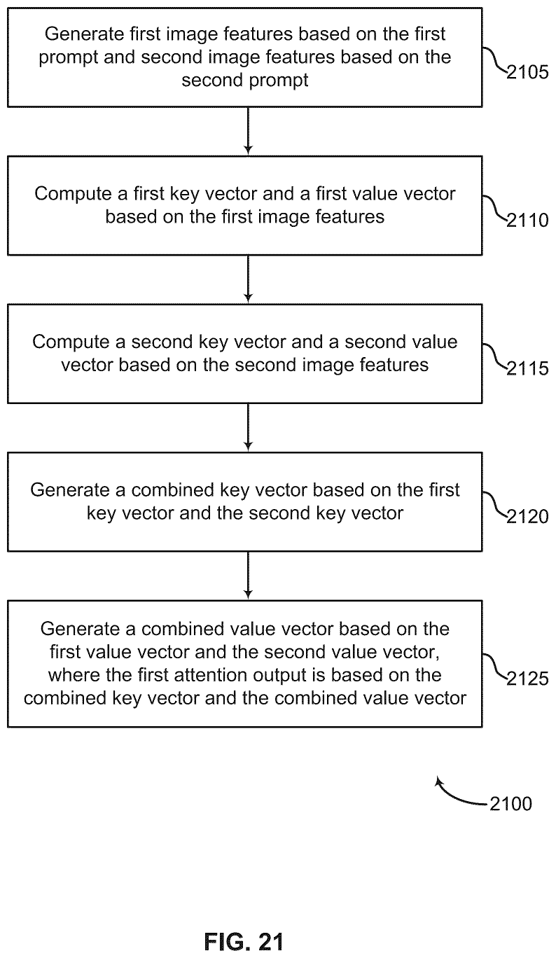

In some cases, memory unit 920 includes a basic input/output system (BIOS) that controls basic hardware or software operations, such as an interaction with peripheral components or devices. In some cases, memory unit 920 includes a memory controller that operates memory cells of memory unit 920. For example, the memory controller may include a row decoder, column decoder, or both. In some cases, memory cells within memory unit 920 store information in the form of a logical state. According to some aspects, memory unit 920 is an example of the memory subsystem 2510 described with reference to FIG. 21.

According to some aspects, image generation apparatus 900 uses one or more processors of processor unit 905 to execute instructions stored in memory unit 920 to perform functions described herein. For example, image generation apparatus 900 may obtain a first prompt and a second prompt, wherein the first prompt describes an object in a first scene and the second prompt describes the object in a second scene different from the first scene. Image generation apparatus 900 generates, using image generation model 935, a first attention output and a second attention output by performing a cross-image attention process, wherein the first attention output is based on the first prompt and the second prompt, and wherein the second attention output is based on the first prompt and the second prompt. Image generation apparatus 900 generates, using image generation model 935, a first synthetic image and a second synthetic image based on the first attention output and the second attention output, respectively, wherein the first synthetic image depicts the object in the first scene and the second synthetic image depicts the object in the second scene.

The memory unit 920 may include a machine learning model 925 trained to obtain a first prompt and a second prompt, wherein the first prompt describes an object in a first scene and the second prompt describes the object in a second scene different from the first scene; generate, using an image generation model, a first attention output and a second attention output by performing a cross-image attention process, wherein the first attention output is based on the first prompt and the second prompt, and wherein the second attention output is based on the first prompt and the second prompt; and generate, using the image generation model, a first synthetic image and a second synthetic image based on the first attention output and the second attention output, respectively, wherein the first synthetic image depicts the object in the first scene and the second synthetic image depicts the object in the second scene. For example, after training, the machine learning model 925 may perform inferencing operations as described with reference to FIGS. 2 and 8.

In some embodiments, the machine learning model 925 is an artificial neural network (ANN) such as the guided diffusion model described with reference to FIG. 15 and the U-Net described with reference to FIG. 16. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of machine learning model 925 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 955 may train the machine learning model 925. For example, parameters of the machine learning model 925 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 23-24). The goal of the training process may be to find optimal values for the parameters that allow the machine learning model to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the machine learning model 925 can be used to make predictions on new, unseen data (i.e., during inference).

I/O module 910 receives inputs from and transmits outputs of the image generation apparatus 900 to other devices or users. For example, I/O module 910 receives inputs for the machine learning model 925 and transmits outputs of the machine learning model 925. According to some aspects, I/O module 910 is an example of the I/O interface 2520 described with reference to FIG. 25.

Machine learning model 925 is an example of, or includes aspects of, the corresponding element described with reference to FIGS. 10-11. In one embodiment, machine learning model 925 includes mask component 930 and image generation model 935. Image generation model 935 is an example of, or includes aspects of, the corresponding element described with reference to FIGS. 15-17.

According to some embodiments, machine learning model 925 obtains a first prompt and a second prompt, where the first prompt describes an object in a first scene and the second prompt describes the object in a second scene different from the first scene. In some examples, machine learning model 925 obtains an object prompt, a first scene prompt, and a second scene prompt. Machine learning model 925 combines the object prompt and the first scene prompt to obtain the first prompt. Machine learning model 925 combines the object prompt and the second scene prompt to obtain the second prompt.

According to some embodiments, mask component 930 generates a first mask corresponding to a location of the object in the first scene. In some examples, mask component 930 generates a second mask corresponding to a location of the object in the second scene, where the first attention output is based on the first mask and the second mask. In some examples, mask component 930 determines a probability value. Mask component 930 randomly modifies one or more pixels of the first mask based on the probability value.

According to some embodiments, image generation model 935 generates a first attention output and a second attention output by performing a cross-image attention process, where the first attention output is based on the first prompt and the second prompt, and where the second attention output is based on the first prompt and the second prompt. In some examples, image generation model 935 generates a first synthetic image and a second synthetic image based on the first attention output and the second attention output, respectively, where the first synthetic image depicts the object in the first scene and the second synthetic image depicts the object in the second scene.

In some examples, image generation model 935 generates a third attention output by performing a subsequent cross-image attention process different from the cross-image attention process, where the cross-image attention process is performed at a first timestep and the subsequent cross-image attention process is performed at a second timestep following the first timestep, and where the first synthetic image is based on the third attention output. In some examples, image generation model 935 obtains a noise input. Image generation model 935 denoises the noise input based on the first prompt and the first attention output. In some examples, image generation model 935 selects a denoising schedule based on a log signal-to-noise ratio (log SNR) function.

According to some embodiments, image generation model 935 (comprising parameters stored in memory unit 920) generates a first synthetic image and a second synthetic image based on the first attention output and the second attention output, respectively, where the first synthetic image depicts the object in the first scene and the second synthetic image depicts the object in the second scene. In some examples, the image generation model 935 includes a diffusion model. In some examples, image generation model 935 includes a cross-image attention layer 940 configured to perform the cross-image attention process.

According to some embodiments, cross-image attention layer 940 generates first image features based on the first prompt and second image features based on the second prompt. In some examples, cross-image attention layer 940 computes a first key vector and a first value vector based on the first image features. The cross-image attention layer 940 computes a second key vector and a second value vector based on the second image features. The cross-image attention layer 940 generates a combined key vector based on the first key vector and the second key vector. The cross-image attention layer 940 generates a combined value vector based on the first value vector and the second value vector, where the first attention output is based on the combined key vector and the combined value vector.

According to some embodiments, cross-image attention layer 940 generates first image features based on the first prompt and second image features based on the second prompt. In some examples, cross-image attention layer 940 computes combined image features based on the first image features and the second image features. The cross-image attention layer 940 computes a query vector, a key vector, and a value vector based on the combined image features, where the first attention output is based on the query vector, the key vector, and the value vector. In some examples, the cross-image attention process includes an inner cross-image attention process, and where the subsequent cross-image attention process includes an outer cross-image attention process.

According to some embodiments, cross-image attention layer 940 generates a first attention output and a second attention output by performing a cross-image attention process, where the first attention output is based on a first prompt and a second prompt, where the second attention output is based on the first prompt and the second prompt, and where the first prompt describes an object in a first scene and the second prompt describes the object in a second scene different from the first scene. In some examples, the cross-image attention layer 940 is located within a decoder of the image generation model 935. Cross-image attention layer 940 is an example of, or includes aspects of, the corresponding element described with reference to FIGS. 10 and 11.

FIG. 10 shows an example of inner cross-image attention according to aspects of the present disclosure. The example shown includes cross-image attention layer 1000, first image features 1005, second image features 1010, linear layer 1015, query vector 1020, key vector 1025, value vector 1030, feature sharing layer 1035, attention layer 1040, and attention output 1045. Cross-image attention layer 1000 is an example of, or includes aspects of, the corresponding element described with reference to FIGS. 9 and 11.

In some embodiments, an image generation model generates a first synthetic image and a second synthetic image based on a first attention output representing a first prompt and a second attention output representing a second prompt, respectively. The first synthetic image depicts the object in the first scene and the second synthetic image depicts the object in the second scene.

Attention output 1045 illustrates how the first attention output (and the second attention output) are generated using an inner cross-image attention process. That is, attention output 1045 can represent a first attention output related to a first synthetic image or a second attention output related to a second synthetic image. Both are generated based on feature sharing with each other so that the resulting images depict a consistent object.

In an embodiment, image generation model 935 (as described in FIG. 9) generates first image features 1005 based on a first prompt and generates second image features 1010 based on a second prompt. The image features are input to linear layer 1015 to obtain query vector 1020. The image features are input to linear layer 1015 to obtain key vector 1025. The image features are input to linear layer 1015 to obtain value vector 1030. In some examples, the image features are projected into query, key, and value independently. The interaction between key and value are calculated based on Equation (8) and Equation (9). This strategy is suitable for a sequence of images, represented as I₁, I₂, etc. The attention weights undergo modification by incorporating masks (see Equation (7)) before applying softmax function (Equation (10)). In Equation (7), M₁, M₁, . . . , Mₙ represent the subject-relevant masked areas. These are computed by averaging and thresholding the cross-attention maps corresponding to subject tokens across diffusion timesteps and layers. This confines the interaction within subject-relevant areas. Key vector 1025 and value vector 1030 are input to feature sharing layer 1035 and attention layer 1040. The cross-image attention layer 1000 generates, via an inner cross-image attention process, the attention output 1045.

First image features 1005 is an example of, or includes aspects of, the corresponding element described with reference to FIG. 11. Second image features 1010 is an example of, or includes aspects of, the corresponding element described with reference to FIG. 11. Linear layer 1015 is an example of, or includes aspects of, the corresponding element described with reference to FIG. 11.

Query vector 1020 is an example of, or includes aspects of, the corresponding element described with reference to FIG. 11. Key vector 1025 is an example of, or includes aspects of, the corresponding element described with reference to FIG. 11. Value vector 1030 is an example of, or includes aspects of, the corresponding element described with reference to FIG. 11. Feature sharing layer 1035 is an example of, or includes aspects of, the corresponding element described with reference to FIG. 11. Attention layer 1040 is an example of, or includes aspects of, the corresponding element described with reference to FIG. 11. Attention output 1045 is an example of, or includes aspects of, the corresponding element described with reference to FIG. 11.

FIG. 11 shows an example of outer cross-image attention according to aspects of the present disclosure. The example shown includes cross-image attention layer 1100, first image features 1105, second image features 1110, feature sharing layer 1115, refined first image features 1120, refined second image features 1125, linear layer 1130, query vector 1135, key vector 1140, value vector 1145, attention layer 1150, and attention output 1155. Cross-image attention layer 1100 is an example of, or includes aspects of, the corresponding element described with reference to FIGS. 9 and 10.

In some embodiments, an image generation model generates a first synthetic image and a second synthetic image based on a first attention output representing a first prompt and a second attention output representing a second prompt, respectively. The first synthetic image depicts the object in the first scene and the second synthetic image depicts the object in the second scene.

In some embodiments, the first prompt and the second prompt are encoded to obtain first and second image features representing the first scene and the second scene, respectively. The first and second image features can be process (either simultaneously or in different image generation processes) at an attention layer of the image generation model to obtain the first attention output (i.e., first modified image features based primarily on the first image features but modified based on the second image features) and the second attention output (i.e., second modified image features based primarily on the second image features but modified based on the first image features). The first attention output can represent the object in the first scene whereas the second attention output represents the same object in the second scene. Because both attention outputs depend on both image features, the object can be consistent in both scenes. For example, as shown in FIG. 4, the same dog can be depicted walking in a park (an example of a first scene) and lying in a field of wildflowers (an example of a second scene).

Attention output 1155 illustrates how the first attention output (and the second attention output) are generated using an outer cross-image attention process. That is, attention output 1155 can represent a first attention output related to a first synthetic image or a second attention output related to a second synthetic image. Both are generated based on feature sharing with each other so that the resulting images depict a consistent object.

Referring to FIG. 11, all image features engage in mutual interaction by sharing features within the subject-relevant area. Consider a batch of n image samples, denoted as {I₁, I₂, . . . , Iₙ}. Each image sample is transformed according to Equation (11) to derive a new feature for each sample. Each sample attends to all its tokens and the subject-area masked on others. The shared features subsequently undergo a linear projection to generate query (Q), key (K), and value (V). The attention is then calculated following Equation (1) below.

In some examples, first image features 1105 and second image features 1110 are input to feature sharing layer 1115 to obtain refined first image features 1120 and refined second image features 1125, respectively. The refined image features are input to linear layer 1130 to obtain query vector 1135, key vector 1140, value vector 1145, respectively. Query vector 1135, key vector 1140, and value vector 1145 are then input to attention layer 1150 to obtain attention output 1155. The cross-image attention layer 1100 generates, via an outer cross-image attention process, the attention output 1155.

Image generation model 935 (as described in FIG. 9) performs self-attention in a diffusion model. The self-attention layer is configured to shape the semantics, structure and layout of the image generated by the diffusion model. The self-attention layer handles a series of tokens, each containing features that represent a unique image patch. Each token is transformed through linear projections using three self-attention matrices: W_{q}, Wₖ, and Wᵥ, producing the “Queries”, “Keys”, and “Values”, respectively. The self-attention map is then computed as follows:

$${A}_{self} = softmax ( {Q}_{img} \cdot {K}_{img}^{T} / \sqrt{{d}_{k}} ) \qquad ( 1 )$$

where dₖ is the feature dimension of the projections.

This map provides a match score between every pair of patches in the image, guiding the influence of the “Value” features of a target patch on a source patch. The intermediary set of hidden features, indicated by h_{img}, is calculated as follows:

$${h}_{img} = {A}_{self} \cdot {V}_{img} \qquad ( 2 )$$

These hidden features are then projected using a fourth matrix, the “output-projection” matrix W₀, yielding W₀·h_{img}, which is then combined with the input features x to create the input for the next layer:

$${x}_{img}^{′} = {W}_{0} \cdot {h}_{img} + {x}_{img} \qquad ( 3 )$$

Embodiments of the present disclosure modify this self-attention mechanism within the diffusion model, providing control over the pose, variation, and consistency of characters in a set of synthetic images generated by image generation model 935.

First image features 1105 is an example of, or includes aspects of, the corresponding element described with reference to FIG. 10. Second image features 1110 is an example of, or includes aspects of, the corresponding element described with reference to FIG. 10. Feature sharing layer 1115 is an example of, or includes aspects of, the corresponding element described with reference to FIG. 10. Linear layer 1130 is an example of, or includes aspects of, the corresponding element described with reference to FIG. 10.

Query vector 1135 is an example of, or includes aspects of, the corresponding element described with reference to FIG. 10. Key vector 1140 is an example of, or includes aspects of, the corresponding element described with reference to FIG. 10. Value vector 1145 is an example of, or includes aspects of, the corresponding element described with reference to FIG. 10. Attention layer 1150 is an example of, or includes aspects of, the corresponding element described with reference to FIG. 10. Attention output 1155 is an example of, or includes aspects of, the corresponding element described with reference to FIG. 10.

In some embodiments, the first prompt and the second prompt are encoded to obtain first and second image features representing the first scene and the second scene, respectively. The first and second image features can be process (either simultaneously or in different image generation processes) at an attention layer of the image generation model to obtain the first attention output (i.e., first modified image features based primarily on the first image features but modified based on the second image features) and the second attention output (i.e., second modified image features based primarily on the second image features but modified based on the first image features). The first attention output can represent the object in the first scene whereas the second attention output represents the same object in the second scene. Because both attention outputs depend on both image features, the object can be consistent in both scenes.

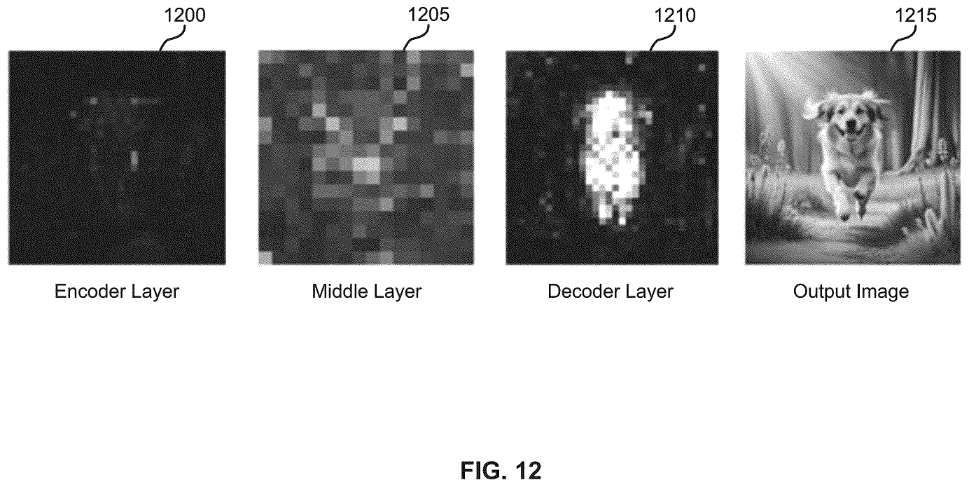

FIG. 12 shows an example of cross-attention map at an intermediate step across different layers according to aspects of the present disclosure. The example shown includes encoder layer 1200, middle layer 1205, decoder layer 1210, and synthetic image 1215.

In some embodiments, image generation model 935 (described with reference to FIG. 9) performs selective cross-image attention injection at inference time. Attention layers in a diffusion model are used to control image layout and correlation with the input prompt (e.g., a text prompt). However, intuitively performing cross-image attention sharing on all layers and among all denoising steps may result in all consistent images that are nearly the same (i.e., lack of diversity in generated images). In some examples, the impact of modifying self-attention maps at various stages and layers within the diffusion model is thoroughly investigated. Based on example experiments, it has been shown that the Query features in the shallow layers of a U-Net (e.g., encoder part of the U-Net) cannot obtain clear layout and structure corresponding to an input prompt (see the first image from the left).

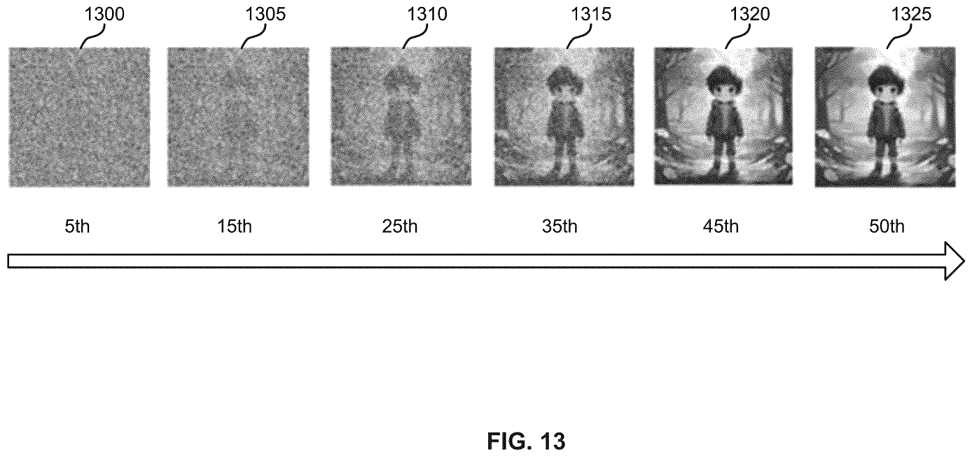

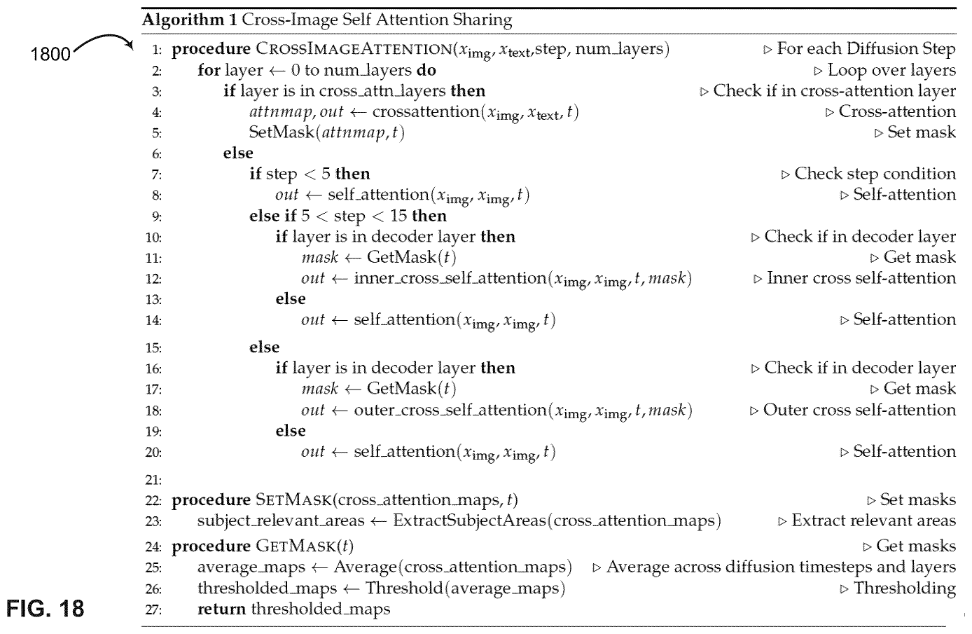

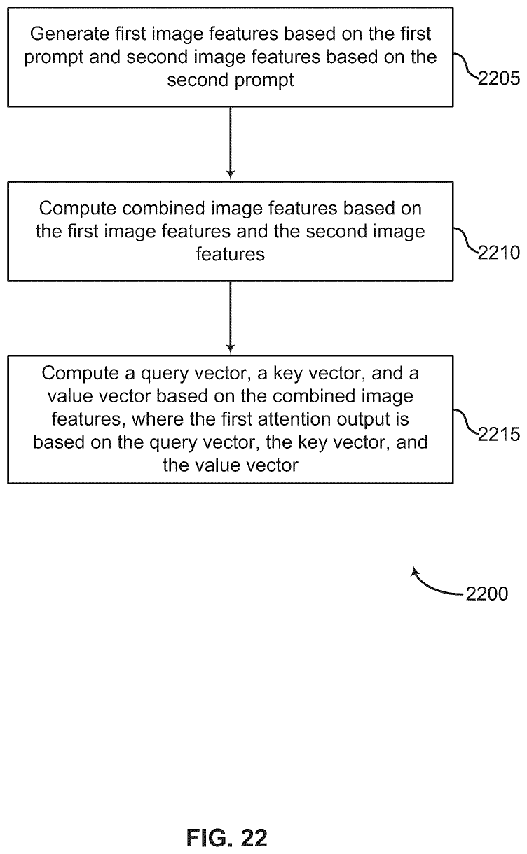

In some embodiments, image generation model 935 restricts attention sharing to the decoder layers of the U-Net. However, preserving noise vector alignment in subject relevant area, even when the subject is not clearly defined (as illustrated in FIG. 13), is important for future layer formation. The sharing of inner cross-image attention is beneficial during the initial noisy stages of diffusion timesteps. An inner cross-image attention process is described with reference to FIGS. 10 and 21. This process aids in aligning image features by distributing keys and values across images. This alignment is crucial for effective sharing in subsequent layers, leading to consistent subject formation. After the 15th iteration, once the subject layout starts becoming visible, image generation model 935 employs an outer cross-image attention sharing process (described with reference to FIGS. 11 and 22). This method aligns spatial features, produces coherent textures, and ensures a harmonious variation in color (see algorithm 1800 in FIG. 18). To mitigate overfitting and disruption in the desired spatial layout, image generation model 935 skips cross-image attention sharing in the first 5 steps of the consistent image generation process. Additionally, outer cross-image attention mechanism is less computationally intensive, facilitating consistent subject generation for larger prompt batches.

FIG. 13 shows an example of predicted image at different diffusion timesteps according to aspects of the present disclosure. The example shown includes first predicted image 1300, second predicted image 1305, third predicted image 1310, fourth predicted image 1315, fifth predicted image 1320, and sixth predicted image 1325. Preserving noise vector alignment in subject relevant area, even when the subject is not clearly defined is important for future layer formation. As an example shown in FIG. 13, first predicted image 1300, second predicted image 1305, third predicted image 1310, fourth predicted image 1315, fifth predicted image 1320, and sixth predicted image 1325 correspond to a predicted image at 5th timestep, 15th timestep, 25th timestep, 35th timestep, 45th timestep, and 50th timestep. The subject is more clearly defined in third predicted image 1310 compared to second predicted image 1305. Similarly, the subject is more clearly defined in fourth predicted image 1315 compared to third predicted image 1310.

FIG. 14 shows an example of comparison between uniform and log SNR scheduling according to aspects of the present disclosure. The example shown includes first prompt 1400, first synthetic image 1405, second prompt 1410, second synthetic image 1415, third synthetic image 1420, and fourth synthetic image 1425.

The process of text-guided image generation is impacted by the noise scheduling functions used in diffusion models. The conventional inference time sampling function may introduce artifacts when implementing a cross-image attention sharing mechanism. In some examples, image generation model 935 (as described in FIG. 9) applies a log signal-to-noise ratio (log SNR) function for inference timestep sampling. Artifacts in generated images are thereby removed and image quality is increased. Different from a uniform noise schedule function, the log SNR noise schedule function is selected (for the U-Net during the inference time) because log SNR schedule function samples dense timesteps when close to the final image, this makes sure that almost no artifacts can appear at the end of the denoising process.

In some examples, a user provides a first prompt 1400 (“dog sitting in snow”) and a second prompt 1410 (“dog running in park”). Machine learning model 925 as described in FIG. 9 generates, using uniform scheduling, the first synthetic image 1405 and second synthetic image 1415 based on first prompt 1400 and second prompt 1410, respectively. For purpose of comparison, machine learning model 925 generates, using log SNR scheduling, the third synthetic image 1420 and fourth synthetic image 1425 based on first prompt 1400 and second prompt 1410, respectively.

The first synthetic image 1405 and second synthetic image 1415 include artifacts (e.g., noise, undesired visual elements). These artifacts are inherent in uniform noise scheduling during the inference process. The third synthetic image 1420 and fourth synthetic image 1425 show increased image quality with fewer to no artifacts. The log SNR scheduling facilitates denser sampling of timesteps as the denoising process approaches the end, accordingly artifacts can be removed to increase overall image quality.

First prompt 1400 is an example of, or includes aspects of, the corresponding element described with reference to FIG. 5. First synthetic image 1405 is an example of, or includes aspects of, the corresponding element described with reference to FIGS. 3-7.

Second prompt 1410 is an example of, or includes aspects of, the corresponding element described with reference to FIG. 5. Second synthetic image 1415 is an example of, or includes aspects of, the corresponding element described with reference to FIGS. 3-7.

Third synthetic image 1420 is an example of, or includes aspects of, the corresponding element described with reference to FIGS. 4-7. Fourth synthetic image 1425 is an example of, or includes aspects of, the corresponding element described with reference to FIGS. 5-7.

FIG. 15 shows an example of a guided diffusion model according to aspects of the present disclosure. The guided latent diffusion model 1500 depicted in FIG. 15 is an example of, or includes aspects of, the corresponding element (i.e., image generation model 935) described with reference to FIG. 9.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Types of diffusion models include Denoising Diffusion Probabilistic Models (DDPMs) and Denoising Diffusion Implicit Models (DDIMs). In DDPMs, the generative process includes reversing a stochastic Markov diffusion process. DDIMs, on the other hand, use a deterministic process so that the same input results in the same output. Diffusion models may also be characterized by whether the noise is added to the image itself, or to image features generated by an encoder (i.e., latent diffusion).

Diffusion models work by iteratively adding noise to the data during a forward process and then learning to recover the data by denoising the data during a reverse process. For example, during training, guided latent diffusion model 1500 may take an original image 1505 in a pixel space 1510 as input and apply and image encoder 1515 to convert original image 1505 into original image features 1520 in a latent space 1525. Then, a forward diffusion process 1530 gradually adds noise to the original image features 1520 to obtain noisy features 1535 (also in latent space 1525) at various noise levels.

Next, a reverse diffusion process 1540 (e.g., a U-Net ANN) gradually removes the noise from the noisy features 1535 at the various noise levels to obtain denoised image features 1545 in latent space 1525. In some examples, the denoised image features 1545 are compared to the original image features 1520 at each of the various noise levels, and parameters of the reverse diffusion process 1540 of the diffusion model are updated based on the comparison. Finally, an image decoder 1550 decodes the denoised image features 1545 to obtain an output image 1555 in pixel space 1510. In some cases, an output image 1555 is created at each of the various noise levels. The output image 1555 can be compared to the original image 1505 to train the reverse diffusion process 1540.

In some cases, image encoder 1515 and image decoder 1550 are pre-trained prior to training the reverse diffusion process 1540. In some examples, image encoder 1515 and image decoder 1550 are trained jointly, or the image encoder 1515 and image decoder 1550 and fine-tuned jointly with the reverse diffusion process 1540.

The reverse diffusion process 1540 can also be guided based on a text prompt 1560, or another guidance prompt, such as an image, a layout, a segmentation map, etc. The text prompt 1560 can be encoded using a text encoder 1565 (e.g., a multimodal encoder) to obtain guidance features 1570 in guidance space 1575. The guidance features 1570 can be combined with the noisy features 1535 at one or more layers of the reverse diffusion process 1540 to ensure that the output image 1555 includes content described by the text prompt 1560. For example, guidance features 1570 can be combined with the noisy features 1535 using a cross-attention block within the reverse diffusion process 1540.

FIG. 16 shows an example of a U-Net 1600 architecture according to aspects of the present disclosure. In some examples, U-Net 1600 is an example of the component that performs the reverse diffusion process 1540 of guided latent diffusion model 1500 described with reference to FIG. 15 and includes architectural elements of the image generation model 935 described with reference to FIG. 9. The U-Net 1600 depicted in FIG. 16 is an example of, or includes aspects of, the architecture used within the reverse diffusion process described with reference to FIG. 15.

In some examples, diffusion models are based on a neural network architecture known as a U-Net. The U-Net 1600 takes input features 1605 having an initial resolution and an initial number of channels and processes the input features 1605 using an initial neural network layer 1610 (e.g., a convolutional network layer) to produce intermediate features 1615. The intermediate features 1615 are then down-sampled using a down-sampling layer 1620 such that down-sampled features 1625 have a resolution less than the initial resolution and a number of channels greater than the initial number of channels.

This process is repeated multiple times, and then the process is reversed. That is, the down-sampled features 1625 are up-sampled using up-sampling process 1630 to obtain up-sampled features 1635. The up-sampled features 1635 can be combined with intermediate features 1615 having the same resolution and number of channels via a skip connection 1640. These inputs are processed using a final neural network layer 1645 to produce output features 1650. In some cases, the output features 1650 have the same resolution as the initial resolution and the same number of channels as the initial number of channels.

In some cases, U-Net 1600 takes additional input features to produce conditionally generated output. For example, the additional input features could include a vector representation of an input prompt. The additional input features can be combined with the intermediate features 1615 within the neural network at one or more layers. For example, a cross-attention module can be used to combine the additional input features and the intermediate features 1615.

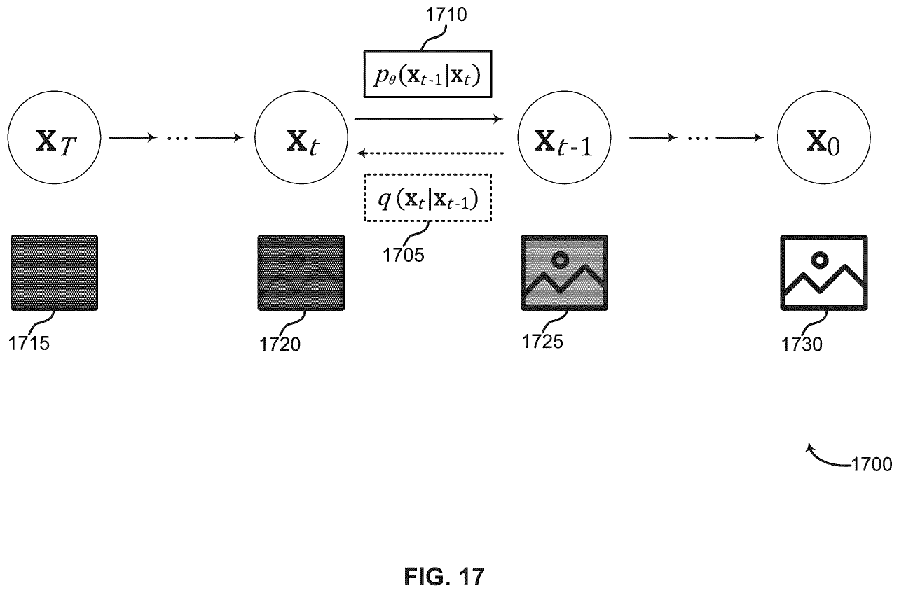

FIG. 17 shows an example of a diffusion process 1700 according to aspects of the present disclosure. In some examples, diffusion process 1700 describes an operation of the image generation model 935 described with reference to FIG. 9, such as the reverse diffusion process 1540 of guided latent diffusion model 1500 described with reference to FIG. 15.

As described above with reference to FIGS. 15 and 17, using a diffusion model can involve both a forward diffusion process 1705 for adding noise to a media item (or features in a latent space) and a reverse diffusion process 1710 for denoising the media item (or features) to obtain a denoised media item. The forward diffusion process 1705 can be represented as q(xₜ|xₜ₋₁), and the reverse diffusion process 1710 can be represented as p(xₜ₋₁|xₜ). In some cases, the forward diffusion process 1705 is used during training to generate media items with successively greater noise, and a neural network is trained to perform the reverse diffusion process 1710 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1710, the model begins with noisy data x_{T}, such as a noisy media item 1715 and denoises the data to obtain the p(xₜ₋₁|xₜ). At each step t−1, the reverse diffusion process 1710 takes xₜ, such as first intermediate media item 1720, and t as input. Here, t represents a step in the sequence of transitions associated with different noise levels, The reverse diffusion process 1710 outputs xₜ₋₁, such as second intermediate media item 1725 iteratively until x_{T} reverts back to x₀, the original media item 1730. The reverse process can be represented as:

$${p}_{θ} ( {x}_{t - 1} \vert {x}_{t} ) : = N ( {x}_{t - 1} ; {μ}_{θ} ( {x}_{t} , t ) , {\sum }_{θ} ( {x}_{t} , t ) ) . \qquad ( 4 )$$

The joint probability of a sequence of samples in the Markov chain can be written as a product of conditionals and the marginal probability:

$${x}_{T} \text{:} {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 5 )$$

where p(x_{T})=N(x_{T}; 0, I) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At inference time, observed data x₀ in a pixel space can be mapped into a latent space as input and a generated data \tilde{x} is mapped back into the pixel space from the latent space as output. In some examples, x₀ represents an original input media item with low quality, latent variables x₁, . . . , x_{T} represent noisy media items, and x represents the generated item with high quality.

In FIGS. 9-17, an apparatus, system, and method for image generation are described. One or more embodiments of the apparatus, system, and method include a memory component; a processing device coupled to the memory component; an image generation model comprising parameters stored in the memory component and configured to: generate a first attention output and a second attention output by performing a cross-image attention process, wherein the first attention output is based on a first prompt and a second prompt, wherein the second attention output is based on the first prompt and the second prompt, and wherein the first prompt describes an object in a first scene and the second prompt describes the object in a second scene different from the first scene; and generate a first synthetic image and a second synthetic image based on the first attention output and the second attention output, respectively, wherein the first synthetic image depicts the object in the first scene and the second synthetic image depicts the object in the second scene.

In some examples, the image generation model comprises a diffusion model. In some examples, the image generation model comprises a cross-image attention layer configured to perform the cross-image attention process. In some examples, the cross-image attention layer is located within a decoder of the image generation model.

### Consistent Character Generation

FIG. 18 shows an example of cross-image self-attention sharing algorithm (i.e., algorithm 1800 for brevity) according to aspects of the present disclosure. At line 1, procedure CrossImageAttention (x_{img}, xₜₑₓₜ, step, num_layers) is executed for each diffusion step. At line 2, loop over layers from layer 0 to num_layers and for each loop, algorithm 1800 performs steps of line 3 to line 20.

At line 3, check if the current layer is in cross-attention layer; if so, perform steps of line 4 to line 5; if else, perform steps of line 7 to line 20. At line 4, if the current layer is a cross-attention layer, execute function crossatention(x_{img}, xₜₑₓₜ, t) which outputs an attention map (attnmap) and other features (out). At line 5, procedure SetMask is called with parameters of attnmap and the current time t to set mask.

At line 7, check if the current step is less than 5. If true, move to line 8 where self_attention(x_{img}, x_{img}, t) is executed to produce an output (out). If the step condition at line 7 is not satisfied (i.e., not true), move to line 9, where algorithm 1800 checks if the step is between 5 and 15. If this condition is true, algorithm 1800 proceeds to line 10 to check if the current layer is a decoder layer (i.e., a layer in the decoder). If it is a decoder layer, then algorithm 1800 executes line 11 to call function GetMask(t) to get mask. At line 12, function inner_cross_self_attention(x_{img}, x_{img}, t, mask) is executed and its result is assigned to out. If the layer is not a decoder layer at line 10, move to line 14 to run function self_attention (x_{img}, x_{img}, t) and its output is assigned to out.

If the conditions at lines 7 and 9 are not satisfied (i.e., false), algorithm 1800 proceeds to line 16 to check if the current layer is a decoder layer (i.e., a layer in the decoder). If true, run GetMask (t) at line 17 to retrieve the mask. At line 18, algorithm 1800 executes function outer_cross_self_attention(x_img, x_img, t, mask) and its result is assigned to out. If the layer is not a decoder layer at line 16, move to line 20, where function self_attention (x_{img}, x_{img}, t) is executed and its result is assigned to out.

At line 22, algorithm 1800 includes procedure SetMask which takes two parameters (cross_attention_maps and t) as input. At line 23, procedure SetMask extracts subject-relevant-areas from the cross_attention_maps using the ExtractSubjectAreas function. At line 24, algorithm 1800 includes procedure GetMask (t), which calls function Average (cross_attention_maps) and its result is assigned to average_maps at line 25, i.e., average the cross-attention maps across diffusion timesteps and layers. At line 26, algorithm 1800 calls function Threshold (average_maps) to obtain thresholded_maps. At line 27, result thresholded_maps is returned.

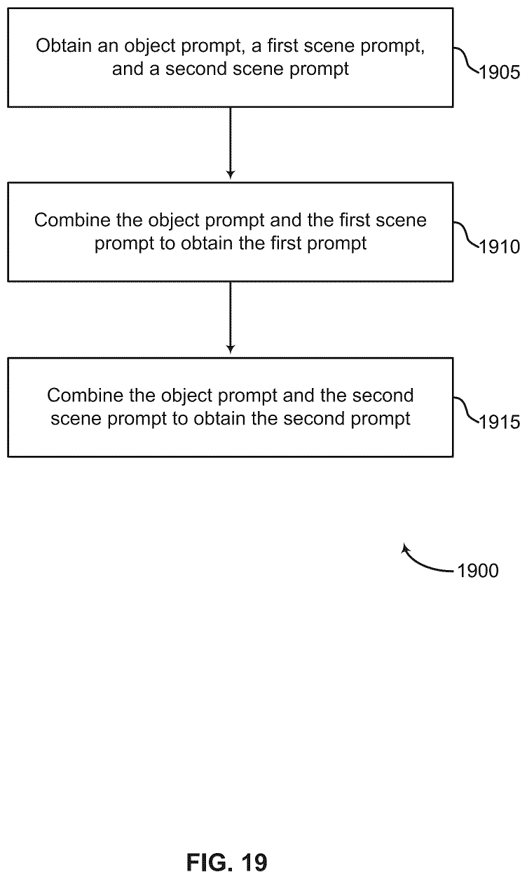

FIG. 19 shows an example of a method 1900 for image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 1905, the system obtains an object prompt, a first scene prompt, and a second scene prompt. In some cases, the operations of this step refer to, or may be performed by, a machine learning model as described with reference to FIG. 9. In some examples, an object prompt is “an anthropomorphic rabbit”. A first scene prompt is “hiking in mountains with walking stick” and a second scene prompt is “riding a bicycle in the street”.

At operation 1910, the system combines the object prompt and the first scene prompt to obtain the first prompt. In some cases, the operations of this step refer to, or may be performed by, a machine learning model as described with reference to FIG. 9. In the example above, the object prompt (“an anthropomorphic rabbit”) and the first scene prompt (“hiking in mountains with walking stick”) are combined to obtain a first prompt “an anthropomorphic rabbit hiking in mountains with walking stick”. The first prompt is input to a text-to-image generation model.

At operation 1915, the system combines the object prompt and the second scene prompt to obtain the second prompt. In some cases, the operations of this step refer to, or may be performed by, a machine learning model as described with reference to FIG. 9. In the example above, the object prompt (“an anthropomorphic rabbit”) and the second scene prompt (“riding a bicycle in the street”) are combined to obtain a second prompt “an anthropomorphic rabbit riding a bicycle in the street”. The second prompt is input to a text-to-image generation model.

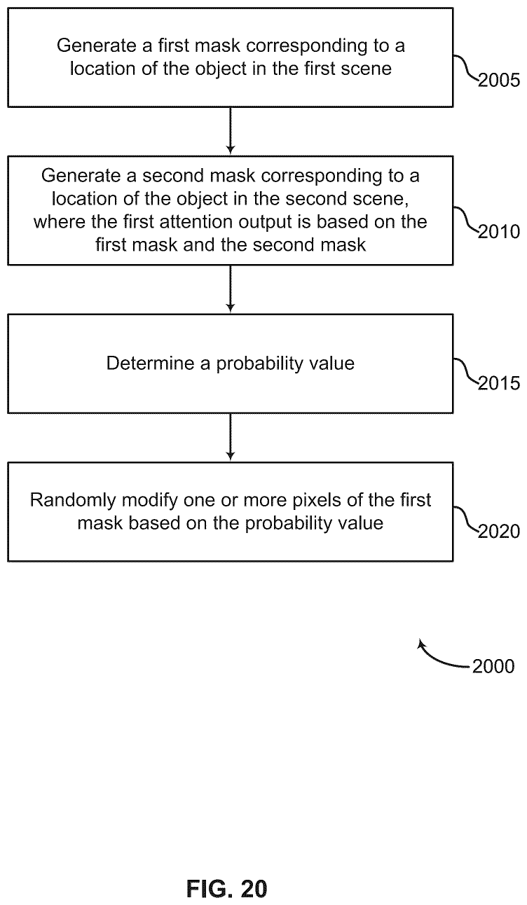

FIG. 20 shows an example of a method 2000 for image generation according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 2005, the system generates a first mask corresponding to a location of the object in the first scene. In some cases, the operations of this step refer to, or may be performed by, a mask component as described with reference to FIG. 9.

In some embodiments, image features are projected into query, key, and value independently. The interaction between key and value is calculated following Equations (8) and (9). This strategy is suitable for a sequence of images, represented as I₁, I₂, etc. The attention weights undergo modification by incorporating masks (refer to Equation (7)) before applying softmax function (see Equation (10)). Here, M₁, M₁, . . . , Mₙ represent the subject-relevant masked areas. The masks are computed by averaging and thresholding the cross-attention maps corresponding to subject tokens across diffusion timesteps and layers. This confines the interaction within subject-relevant areas. In some cases, a first mask is represented as M₁.

At operation 2010, the system generates a second mask corresponding to a location of the object in the second scene, where the first attention output is based on the first mask and the second mask. In some cases, the operations of this step refer to, or may be performed by, a mask component as described with reference to FIG. 9. In some cases, a second mask is represented as M₂.

At operation 2015, the system determines a probability value. In some cases, the operations of this step refer to, or may be performed by, a mask component as described with reference to FIG. 9. In some cases, the layout remains undefined during initial timesteps of image generation from diffusion models (refer to an example shown in FIG. 13). Thus, the generation of masks through thresholding cross-attention maps pertinent to the subject token may result in imperfection. To ensure generalization and prevent information leakage across the background of consistent images, some embodiments incorporate an element of randomness. For example, a Bernoulli distribution is used to generate randomness, represented as mᵢ˜Bernoulli(p) in Equation (6) below.

$${m}_{i} = \{ \begin{matrix}1 & with probability p \\ 0 & with probability 1 - p\end{matrix} \qquad ( 6 )$$

This process introduces randomness into the masks to prevent information leakage in background area, by transforming some of the 1's into 0's with a probability p. In some examples, probability p is set to 0.7 in the context of diffusion models.

At operation 2020, the system randomly modifies one or more pixels of the first mask based on the probability value. In some cases, the operations of this step refer to, or may be performed by, a mask component as described with reference to FIG. 9.

FIG. 21 shows an example of a method 2100 for generating a first attention output and an inner cross-image attention process according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 2105, the system generates first image features based on the first prompt and second image features based on the second prompt. In some cases, the operations of this step refer to, or may be performed by, a cross-image attention layer as described with reference to FIGS. 9-11. In some cases, the first image features are denoted as X₁.

At operation 2110, the system computes a first key vector and a first value vector based on the first image features. In some cases, the operations of this step refer to, or may be performed by, a cross-image attention layer as described with reference to FIGS. 9-11. In some examples, a first key vector is denoted as K₁ and a first value vector is denoted as V₁.

In some embodiments, the image features are projected into query, key, and value independently. The interaction between key and value is calculated following Equations (8) and (9). This strategy is suitable for a sequence of images, represented as I₁, I₂, etc. The attention weights undergo modification by incorporating masks (see Equation (7)) before applying softmax function (see Equation (10)). Here, M₁, M₁, . . . , Mₙ represent the subject-relevant masked areas. These are computed by averaging and thresholding the cross-attention maps corresponding to subject tokens across diffusion timesteps and layers. This confines the interaction within subject-relevant areas.

$${M}_{1}^{′} = [ \begin{matrix}1 & ⊕ & {M}_{1} & ⊕ & … & ⊕ & {M}_{n}\end{matrix} ] \qquad ( 7 )$$

At operation 2115, the system computes a second key vector and a second value vector based on the second image features. In some cases, the operations of this step refer to, or may be performed by, a cross-image attention layer as described with reference to FIGS. 9-11. In some examples, a second key vector is denoted as K₂ and a second value vector is denoted as V₂.

At operation 2120, the system generates a combined key vector based on the first key vector and the second key vector. In some cases, the operations of this step refer to, or may be performed by, a cross-image attention layer as described with reference to FIGS. 9-11. In some examples, a combined key vector is denoted as

$${K}_{1}^{′} .$$

$${K}_{1}^{′} = [ \begin{matrix}{K}_{1} & ⊕ & {K}_{2} & ⊕ & … & ⊕ & {K}_{n}\end{matrix} ] \qquad ( 8 )$$

At operation 2125, the system generates a combined value vector based on the first value vector and the second value vector, where the first attention output is based on the combined key vector and the combined value vector. In some cases, the operations of this step refer to, or may be performed by, a cross-image attention layer as described with reference to FIGS. 9-11. In some examples, a combined value vector is denoted as

$${V}_{1}^{′} .$$

$${V}_{1}^{′} = [ \begin{matrix}{V}_{1} & ⊕ & {V}_{2} & ⊕ & … & ⊕ & {V}_{n}\end{matrix} ] \qquad ( 9 )$$

In an embodiment, the first attention output A is generated based on the combined key vector and the combined value vector. In some cases, the first attention output is an example of attention output 1045 as described with reference to FIG. 10.

$${A}_{1}^{′} = softmax ( {Q}_{1} \cdot {K}_{1}^{′ T} / \sqrt{dk} + log ( {M}_{1}^{′} ) ) \qquad ( 10 )$$

Detail regarding the inner cross-image attention process is further described with reference to FIG. 10. Details regarding computing the combined key vector and the combined value vector are further described with reference to FIG. 10.

FIG. 22 shows an example of a method 2200 for generating a first attention output through an outer cross-image attention process according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 2205, the system generates first image features based on the first prompt and second image features based on the second prompt. In some cases, the operations of this step refer to, or may be performed by, a cross-image attention layer as described with reference to FIGS. 9-11. In some examples, first image features are denoted as X₁.

At operation 2210, the system computes combined image features based on the first image features and the second image features. In some cases, the operations of this step refer to, or may be performed by, a cross-image attention layer as described with reference to FIGS. 9-11. In some examples, combined image features are denoted as

$${X}_{1}^{′} .$$

During an outer cross-image attention sharing processing, all image features engage in mutual interaction by sharing features within the subject-relevant area. Consider a batch of n image samples, denoted as {I₁, I₂, . . . , Iₙ}. Each image sample is transformed according to Equation (11) to derive a new feature for each sample. Each sample attends to all its tokens and the subject-area masked on others.

$${I}_{1}^{′} = [ \begin{matrix}{I}_{1} & ⊕ & {I}_{2} * {M}_{2} & ⊕ & … & ⊕ & {I}_{n} * {M}_{n}\end{matrix} ] \qquad ( 11 )$$

At operation 2215, the system computes a query vector, a key vector, and a value vector based on the combined image features, where the first attention output is based on the query vector, the key vector, and the value vector. In some cases, the operations of this step refer to, or may be performed by, a cross-image attention layer as described with reference to FIGS. 9-11. In some examples, a query vector, a key vector, and a value vector are referred to as Q, K, V, respectively. In some cases, the first attention output is an example of attention output 1155 as described with reference to FIG. 11.

The shared features subsequently undergo a linear projection to generate query (Q), key (K), and value (V). The attention output is then calculated following Equation (1). Detail regarding the outer cross-image attention process is further described with reference to FIG. 11. Details regarding computing a query vector, a key vector, and a value vector are further described with reference to FIG. 11.

FIG. 23 shows an example of a method 2300 for training a diffusion model according to aspects of the present disclosure. In some embodiments, the method 2300 describes an operation of the training component 945 described for configuring the machine learning model 925 as described with reference to FIG. 9. The method 2300 represents an example for training a reverse diffusion process as described above with reference to FIGS. 15 and 17. In some examples, these operations are performed by a system including a processor executing a set of codes to control functional elements of an apparatus, such as the guided latent diffusion model described in FIG. 15.

Additionally or alternatively, certain processes of method 2300 may be performed using special-purpose hardware. Generally, these operations are performed according to the methods and processes described in accordance with aspects of the present disclosure. In some cases, the operations described herein are composed of various substeps or are performed in conjunction with other operations.

At operation 2305, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 2310, the system adds noise to a media item using a forward diffusion process in N stages. In some cases, the forward diffusion process is a fixed process where Gaussian noise is successively added to media item. In latent diffusion models, the Gaussian noise may be successively added to features in a latent space.

At operation 2315, the system at each stage n, starting with stage N, a reverse diffusion process is used to predict the output or features at stage n−1. For example, the reverse diffusion process can predict the noise that was added by the forward diffusion process, and the predicted noise can be removed from the noise input to obtain the predicted output. In some cases, an original media item is predicted at each stage of the training process.

At operation 2320, the system compares predicted output (or features) at stage n−1 to an actual media item (or features), such as the output at stage n−1 or the original input. For example, given observed data x, the diffusion model may be trained to minimize the variational upper bound of the negative log-likelihood-log pe (x) of the training data.

At operation 2325, the system updates parameters of the model based on the comparison. For example, parameters of a U-Net may be updated using gradient descent. Time-dependent parameters of the Gaussian transitions can also be learned.

FIG. 24 shows an example of a step-by-step procedure for training a machine learning model according to aspects of the present disclosure. FIG. 24 shows an example of a step-by-step procedure for training a machine learning model according to aspects of the present disclosure. FIG. 24 shows a flow diagram depicting an algorithm as a step-by-step procedure 2400 in an example implementation of operations performable for training a machine-learning model. In some embodiments, the procedure 2400 describes an operation of the training component 945 described for configuring the machine learning model 925 as described with reference to FIG. 9. The procedure 2400 provides one or more examples of generating training data, use of the training data to train a machine-learning model, and use of the trained machine-learning model to perform a task.

To begin in this example, a machine-learning system collects training data (block 2402) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 2404) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

To train the machine-learning model in the illustrated example, the machine-learning model is first initialized (block 2406). Initialization of the machine-learning model includes selecting a model architecture (block 2408) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 2410). The loss function is utilized to measure a difference between an output of the machine-learning model (i.e., predictions) and target values (e.g., as expressed by the training data) to be used to train the machine-learning model. Additionally, an optimization algorithm is selected (2412) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 2414) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 2418) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 2420), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 2420), the procedure 2400 continues training of the machine-learning model using the training data (block 2418) in this example.

If the stopping criterion is met (“yes” from decision block 2420), the trained machine-learning model is then utilized to generate an output based on subsequent data (block 2422). The trained machine-learning model, for instance, is trained to perform a task as described above and therefore, once trained, is configured to perform that task based on subsequent data received as an input and processed by the machine-learning model.

FIG. 25 shows an example of a computing device 2500 for image processing according to aspects of the present disclosure. The computing device 2500 may be an example of the image generation apparatus 900 described with reference to FIG. 9. In one aspect, computing device 2500 includes processor(s) 2505, memory subsystem 2510, communication interface 2515, I/O interface 2520, user interface component(s) 2525, and channel 2530.

In some embodiments, computing device 2500 is an example of, or includes aspects of, the image generation model of FIG. 9. In some embodiments, computing device 2500 includes one or more processors 2505 that can execute instructions stored in memory subsystem 2510 to perform media generation.

According to some aspects, computing device 2500 includes one or more processors 2505. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 2510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 2515 operates at a boundary between communicating entities (such as computing device 2500, one or more user devices, a cloud, and one or more databases) and channel 2530 and can record and process communications. In some cases, communication interface 2515 is provided to enable a processing system coupled to a transceiver (e.g., a transmitter and/or a receiver). In some examples, the transceiver is configured to transmit (or send) and receive signals for a communications device via an antenna.

According to some aspects, I/O interface 2520 is controlled by an I/O controller to manage input and output signals for computing device 2500. In some cases, I/O interface 2520 manages peripherals not integrated into computing device 2500. In some cases, I/O interface 2520 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 2520 or via hardware components controlled by the I/O controller.

According to some aspects, user interface component(s) 2525 enable a user to interact with computing device 2500. In some cases, user interface component(s) 2525 include an audio device, such as an external speaker system, an external display device such as a display screen, an input device (e.g., a remote-control device interfaced with a user interface directly or through the I/O controller), or a combination thereof. In some cases, user interface component(s) 2525 include a GUI.

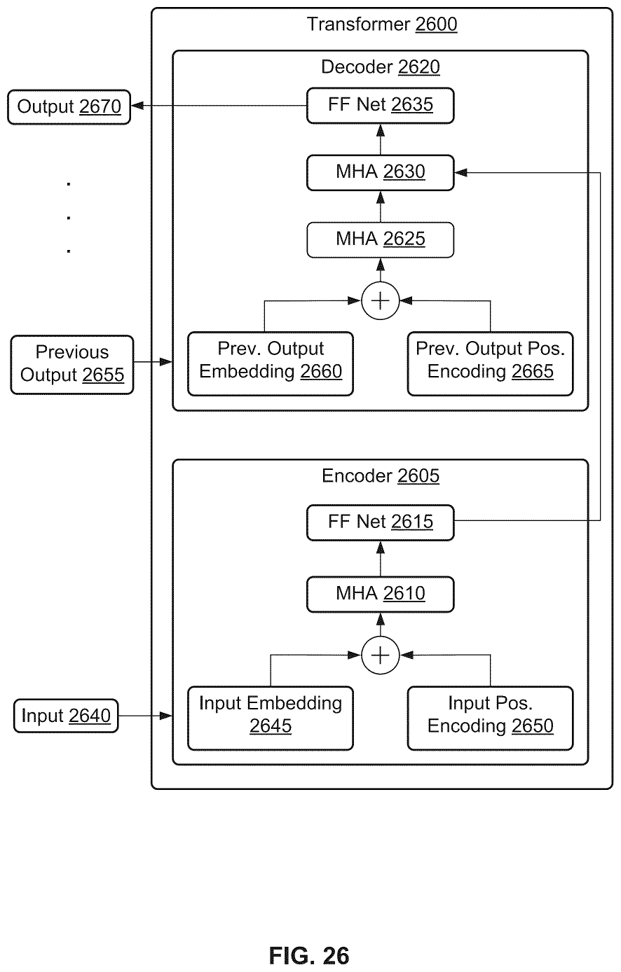

FIG. 26 shows an example of a transformer network according to aspects of the present disclosure. The example shown includes transformer 2600, encoder 2605, decoder 2620, input 2640, input embedding 2645, input positional encoding 2650, previous output 2655, previous output embedding 2660, previous output positional encoding 2665, and output 2670.

In some cases, encoder 2605 includes multi-head self-attention sublayer 2610 and feed-forward network sublayer 2615. In some cases, decoder 2620 includes first multi-head self-attention sublayer 2625, second multi-head self-attention sublayer 2630, and feed-forward network sublayer 2635.

According to some aspects, a machine learning model (such as the machine learning model described with reference to FIGS. 9-11) comprises transformer 2600. In some cases, encoder 2605 is configured to map input 2640 (for example, a query or a prompt comprising a sequence of words or tokens) to a sequence of continuous representations that are fed into decoder 2620. In some cases, decoder 2620 generates output 2670 (e.g., a prediction of an output sequence of words or tokens) based on the output of encoder 2605 and previous output 2655 (e.g., a previously predicted output sequence), which allows for the use of autoregression.

For example, in some cases, encoder 2605 parses input 2640 into tokens and vectorizes the parsed tokens to obtain input embedding 2645, and adds input positional encoding 2650 (e.g., positional encoding vectors for input 2640 of a same dimension as input embedding 2645) to input embedding 2645. In some cases, input positional encoding 2650 includes information about relative positions of words or tokens in input 2640.

In some cases, encoder 2605 comprises one or more encoding layers (e.g., six encoding layers) that generate contextualized token representations, where each representation corresponds to a token that combines information from other input tokens via self-attention mechanism. In some cases, each encoding layer of encoder 2605 comprises a multi-head self-attention sublayer (e.g., multi-head self-attention sublayer 2610). In some cases, the multi-head self-attention sublayer implements a multi-head self-attention mechanism that receives different linearly projected versions of queries, keys, and values to produce outputs in parallel. In some cases, each encoding layer of encoder 2605 also includes a fully connected feed-forward network sublayer (e.g., feed-forward network sublayer 2615) comprising two linear transformations surrounding a Rectified Linear Unit (ReLU) activation:

$$FFN ( x ) = ReLU ( {W}_{1} x + {b}_{1} ) {W}_{2} + {b}_{2}$$

In some cases, each layer employs different weight parameters (W₁, W₂) and different bias parameters (b₁, b₂) to apply a same linear transformation to each word or token in input 2640.

In some cases, each sublayer of encoder 2605 is followed by a normalization layer that normalizes a sum computed between a sublayer input x and an output sublayer (x) generated by the sublayer:

$$layernorm ( x + sublayer ( x ) ) \qquad ( 13 )$$

In some cases, encoder 2605 is bidirectional because encoder 2605 attends to each word or token in input 2640 regardless of a position of the word or token in input 2640.

In some cases, decoder 2620 comprises one or more decoding layers (e.g., six decoding layers). In some cases, each decoding layer comprises three sublayers including a first multi-head self-attention sublayer (e.g., first multi-head self-attention sublayer 2625), a second multi-head self-attention sublayer (e.g., second multi-head self-attention sublayer 2630), and a feed-forward network sublayer (e.g., feed-forward network sublayer 2635). In some cases, each sublayer of decoder 2620 is followed by a normalization layer that normalizes a sum computed between a sublayer input x and an output sublayer (x) generated by the sublayer.

In some cases, decoder 2620 generates previous output embedding 2660 of previous output 2655 and adds previous output positional encoding 2665 (e.g., position information for words or tokens in previous output 2655) to previous output embedding 2660. In some cases, each first multi-head self-attention sublayer receives the combination of previous output embedding 2660 and previous output positional encoding 2665 and applies a multi-head self-attention mechanism to the combination. In some cases, for each word in an input sequence, each first multi-head self-attention sublayer of decoder 2620 attends only to words preceding the word in the sequence, and so transformer 2600's prediction for a word at a particular position only depends on known outputs for a word that came before the word in the sequence. For example, in some cases, each first multi-head self-attention sublayer implements multiple single-attention functions in parallel by introducing a mask over values produced by the scaled multiplication of matrices Q and K by suppressing matrix values that would otherwise correspond to disallowed connections.

In some cases, each second multi-head self-attention sublayer implements a multi-head self-attention mechanism similar to the multi-head self-attention mechanism implemented in each multi-head self-attention sublayer of encoder 2605 by receiving a query Q from a previous sublayer of decoder 2620 and a key K and a value V from the output of encoder 2605, allowing decoder 2620 to attend to each word in the input 2640.

In some cases, each feed-forward network sublayer implements a fully connected feed-forward network similar to feed-forward network sublayer 2615. In some cases, the feed-forward network sublayers are followed by a linear transformation and a softmax function to generate a prediction of output 2670 (e.g., a prediction of a next word or token in a sequence of words or tokens). Accordingly, in some cases, transformer 2600 generates a response as described herein based on a predicted sequence of words or tokens.

Performance of apparatus, systems and methods of the present disclosure have been evaluated, and results indicate embodiments of the present disclosure have obtained increased performance over existing technology. Example experiments demonstrate that the image generation apparatus described in embodiments of the present disclosure outperforms conventional systems.

One or more embodiments provide a training-free, zero-shot image generation model that can do consistent character generation based on textual prompts. The machine learning model described in the present disclosure ensures that characters maintain consistency across multiple length prompts (e.g., 2, 3 or 4) and is compatible with models with larger parameter sizes, such as a diffusion model.

The machine learning model described in the present disclosure is less memory intensive, has faster runtime, generalizes well (can support diverse and multi-subject generation), and the model is not limited to a few prompts. Hence, the machine learning model can be applied to complicated design workflows, including but not limited to, story generation and comic book creation. In some embodiments, the machine learning model implements two different types of cross image attention sharing mechanisms and is aimed at regulating the extent of attention sharing.

As shown in FIGS. 10-11, standard self attention mechanism is replaced with cross image self attention sharing mechanism to generate consistent characters in different pose and background doing different activities. This process involves the manipulation of the attention mechanism in two distinct ways-referred to as inner cross-image attention and outer cross-image attention.

By incorporating the described training free, zero shot methods of inner and outer cross-image self attention sharing, the machine learning model can generate consistent characters across a diverse range of objects, scenarios and styles. This eliminates the need for the constraints of working on text tokens the model has been trained on, the requirement for additional images for test-time fine-tuning. Furthermore, the machine learning model generates characters in different poses, and avoids excessive memory and time requirements due to multiple passes from the diffusion model to maintain consistency. The machine learning model outputs high fidelity of the visually appealing results based on text prompts, while maintaining consistency, layout diversity, and variations, demonstrating its effectiveness. Additionally, the capability to generate multiple consistent characters in images expands its usability, making the model suitable for various applications, including the creation of animated stories. Therefore, the model can be applied in the field of consistent image generation from text prompts.

The results of consistent character generation, as illustrated in FIGS. 3-4, demonstrate the model capability to generate subject consistent images across a wide variety of prompts and scenarios, while maintaining the aesthetic appeal and alignment with the given text prompts. A qualitative comparison of consistency, shown in FIG. 6, demonstrates methods and apparatus of the present disclosure provide competitive performance, but without the need for resource-intensive multiple passes from the diffusion model. The ability to generate multiple consistent subjects (FIG. 7) and maintain consistency across four prompts (FIG. 5) further demonstrates the model's effectiveness.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the concepts described. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The methods described may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining a first prompt and a second prompt, wherein the first prompt describes an object in a first scene and the second prompt describes the object in a second scene different from the first scene;
generating, using an image generation model, a first attention output and a second attention output, wherein each of the first attention output and the second attention output is based on both the first prompt and the second prompt; and
generating, using the image generation model, a first synthetic image and a second synthetic image based on the first attention output and the second attention output, respectively, wherein the first synthetic image depicts the object in the first scene and the second synthetic image depicts the object in the second scene.

2. The method of claim 1, wherein obtaining the first prompt and the second prompt comprises:
obtaining an object prompt, a first scene prompt, and a second scene prompt;
combining the object prompt and the first scene prompt to obtain the first prompt; and
combining the object prompt and the second scene prompt to obtain the second prompt.

3. The method of claim 1, wherein generating the first attention output comprises:
generating a first mask corresponding to a location of the object in the first scene; and
generating a second mask corresponding to a location of the object in the second scene, wherein the first attention output is based on the first mask and the second mask.

4. The method of claim 3, further comprising:
determining a probability value; and
randomly modifying one or more pixels of the first mask based on the probability value.

5. The method of claim 1, wherein generating the first attention output comprises:
generating first image features based on the first prompt and second image features based on the second prompt;
computing a first key vector and a first value vector based on the first image features;
computing a second key vector and a second value vector based on the second image features;
generating a combined key vector based on the first key vector and the second key vector; and
generating a combined value vector based on the first value vector and the second value vector, wherein the first attention output is based on the combined key vector and the combined value vector.

6. The method of claim 1, wherein generating the first attention output comprises:
generating first image features based on the first prompt and second image features based on the second prompt;
computing combined image features based on the first image features and the second image features; and
computing a query vector, a key vector, and a value vector based on the combined image features, wherein the first attention output is based on the query vector, the key vector, and the value vector.

7. The method of claim 1, further comprising:
generating, using the image generation model, a third attention output by performing a subsequent cross-image attention process different from a cross-image attention process that is performed to generate the first attention output and the second attention output, wherein the cross-image attention process is performed at a first timestep and the subsequent cross-image attention process is performed at a second timestep following the first timestep, and wherein the first synthetic image is based on the third attention output.

8. The method of claim 7, wherein:
the cross-image attention process comprises an inner cross-image attention process, and wherein the subsequent cross-image attention process comprises an outer cross-image attention process.

9. The method of claim 1, wherein generating the first synthetic image comprises:
obtaining a noise input; and
denoising the noise input based on the first prompt and the first attention output.

10. The method of claim 9, further comprising:
selecting a denoising schedule based on a log signal-to-noise ratio (log SNR) function.

11. A non-transitory computer readable medium storing code for image processing, the code comprising instructions that, when executed by at least one processor, cause the at least one processor to perform operations comprising:
obtaining a first prompt describing a first scene and a second prompt describing a second scene;
performing cross-image attention between the first prompt and the second prompt to obtain a first attention output corresponding to the first prompt and a second attention output corresponding to the second prompt; and
generating, using an image generation model, a first synthetic image and a second synthetic image based on the first attention output and the second attention output, respectively.

12. The non-transitory computer readable medium of claim 11, the code further comprising instructions executable by the at least one processor to perform operations comprising:
obtaining an object prompt, a first scene prompt, and a second scene prompt;
combining the object prompt and the first scene prompt to obtain the first prompt; and
combining the object prompt and the second scene prompt to obtain the second prompt.

13. The non-transitory computer readable medium of claim 11, the code further comprising instructions executable by the at least one processor to perform operations comprising:
generating a first mask corresponding to a location of an object in the first scene; and
generating a second mask corresponding to a location of the object in the second scene, wherein the first attention output is based on the first mask and the second mask.

14. The non-transitory computer readable medium of claim 11, the code further comprising instructions executable by the at least one processor to perform operations comprising:
generating first image features based on the first prompt and second image features based on the second prompt;
computing a first key vector and a first value vector based on the first image features;
computing a second key vector and a second value vector based on the second image features;
generating a combined key vector based on the first key vector and the second key vector; and
generating a combined value vector based on the first value vector and the second value vector, wherein the first attention output is based on the combined key vector and the combined value vector.

15. The non-transitory computer readable medium of claim 11, the code further comprising instructions executable by the at least one processor to perform operations comprising:
generating first image features based on the first prompt and second image features based on the second prompt;
computing combined image features based on the first image features and the second image features; and
computing a query vector, a key vector, and a value vector based on the combined image features, wherein the first attention output is based on the query vector, the key vector, and the value vector.

16. The non-transitory computer readable medium of claim 11, the code further comprising instructions executable by the at least one processor to perform operations comprising:
generating, using the image generation model, a third attention output by performing a subsequent cross-image attention process different from a cross-image attention process that is performed to generate the first attention output and the second attention output, wherein the cross-image attention process is performed at a first timestep and the subsequent cross-image attention process is performed at a second timestep following the first timestep, and wherein the first synthetic image is based on the third attention output.

17. An apparatus comprising:
a memory component;
a processing device coupled to the memory component; and
an image generation model comprising parameters stored in the memory component and configured to generate a first attention output and a second attention output by performing a cross-image attention process on a first prompt that describes a first scene and a second prompt that describes a second scene, and to generate a first synthetic image and a second synthetic image based on the first attention output and the second attention output, respectively, wherein the first synthetic image depicts an object in the first scene and the second synthetic image depicts the object in the second scene.

18. The apparatus of claim 17, wherein:
the image generation model comprises a diffusion model.

19. The apparatus of claim 17, wherein:
the image generation model comprises a cross-image attention layer configured to perform the cross-image attention process.

20. The apparatus of claim 19, wherein:
the cross-image attention layer is located within a decoder of the image generation model.
